(19) United States
(12) Patent Application Publication
(10) Pub. No.: US 2022/0246042 A1
(43) Pub. Date: Aug. 4, 2022

(54) AVIATION-BASED PLATFORM

(71) Applicant: CHIRP Technologies Inc, Toronto (CA)

(72) Inventors: Charan Kumar Bommireddipalli, Toronto (CA); Timothy Edward Ray, Etobicoke (CA)

(21) Appl. No.: 17/162,432

(22) Filed: Jan. 29, 2021

(51) Int. Cl. G08G 5/00; G06Q 10/02; G06Q 10/04; G06F 16/9035

(52) U.S. Cl. CPC G08G 5/0034; G08G 5/0039; G06F 16/9035; G06Q 10/04; G06Q 10/02

(57) ABSTRACT

Systems and methods for flight-based platforms are disclosed. For example, the platform may allow for travelers, brokers, operators, and owners of private aerial vehicles to schedule, manage, and augment flights and flight data. The platform may allow for secure and timely communication between entities involved in flights as well as for provision of time-sensitive, dynamic flight information to allow for accurate, safe, and personalized flight booking.

### BACKGROUND

Private aviation, such as the use of private jets to transport a small group of people, is available. Private aviation can be more expensive, personalized, and difficult to manage as compared to passenger travel through commercial airliners. Described herein are improvements in technology and solutions to technical problems that can be used to, among other things, assist in private aviation.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 illustrates a schematic diagram of an example environment for an aviation-based user platform.

FIG. 2 illustrates a sequence diagram showing an example process associated with an aviation-based user platform.

FIG. 3 illustrates an example user interface for use by one or more aerial vehicle travelers associated with an aviation-based user platform.

FIG. 4 illustrates an example user interface for use by one or more aerial vehicle flight brokers associated with an aviation-based user platform.

FIG. 5 illustrates an example user interface for use by one or more aerial vehicle operators associated with an aviation-based user platform.

FIG. 6 illustrates an example user interface for use by one or more aerial vehicle owners associated with an aviation-based user platform.

FIG. 7 illustrates a flow diagram of an example process for tracking staff members associated with a scheduled flight via an aviation-based user platform.

FIG. 8 illustrates a flow diagram of an example process for identifying and presenting unscheduled but available flights via an aviation-based user platform.

FIG. 9 illustrates a flow diagram of an example process for authorizing and utilizing proxies for scheduling flights via an aviation-based user platform.

FIG. 10 illustrates a flow diagram of an example process for generation of flight manifest data associated with an aviation-based user platform.

FIG. 11 illustrates a flow diagram of an example process for utilizing aerial vehicle operator functionality associated with an aviation-based user platform.

FIG. 12 illustrates a flow diagram of another example process for utilizing aerial vehicle operator functionality associated with an aviation-based user platform.

FIG. 13 illustrates a flow diagram of an example process for utilizing aerial vehicle traveler and aerial vehicle flight broker functionality associated with an aviation-based user platform.

FIG. 14 illustrates a flow diagram of another example process for utilizing aerial vehicle traveler and aerial vehicle flight broker functionality associated with an aviation-based user platform.

FIG. 15 illustrates a flow diagram of an example process for messaging security associated with an aviation-based user platform.

FIG. 16 illustrates a flow diagram of another example process for messaging security associated with an aviation-based user platform.

FIG. 17 illustrates a flow diagram of an example process for flight manifest data generation.

FIG. 18 illustrates a flow diagram of another example process for flight manifest data generation.

FIG. 19 illustrates a flow diagram of an example process for enabling and utilizing auto-booking functionality associated with an aviation-based user platform.

FIG. 20 illustrates a flow diagram of another example process for enabling and utilizing auto-booking functionality associated with an aviation-based user platform.

### DETAILED DESCRIPTION

Systems and methods for aviation-based user platforms are disclosed. Take, for example, a situation where one or more aerial vehicle travelers desire to book an aerial vehicle for use by those travelers, particularly when the aerial vehicle is considered a private aerial vehicle such as a private jet and/or helicopter for example. The aerial vehicle may be owned by an aerial vehicle owner who may engage with an aerial vehicle operator to perform actions associated with operating the aerial vehicle. To assist in booking the aerial vehicle for flights, the aerial vehicle operator engages with one or more aerial vehicle flight brokers, who communicate with potential aerial vehicle travelers to sell flights on the aerial vehicle. Typically, the aerial vehicle flight broker contacts potential aerial vehicle travelers and/or the aerial vehicle travelers contact the flight broker in search of a private flight. This communication is typically performed via email and/or over the phone, and the traveler provides information indicating a date and/or time when the aerial vehicle would be desired for use. The broker then communicates with the operators that the broker is associated with in an attempt to match the traveler's flight criteria with aerial vehicles that are operated by the operators. The operators then identify the aerial vehicles and potential flights that they feel best match the traveler's criteria and bid on the flight. The flight bid may include information about the flight, such as a type of aerial vehicle, departure time, available amenities, etc., and the information may also include a quoted price for the flight. The broker may compile bids from the various operators and communicate those bids back to the traveler, who may select one of the bids for scheduling a flight. The broker may then communicate the selection to the applicable operator, who may make preparations to have the aerial vehicle and staff ready for the scheduled flight at the departure time. While this typical process allows for the scheduling of private flights, it does not provide a centralized location for making flights available, flight searching, messaging services, transaction services, and a litany of other functionality for promoting the secure, accurate, and timely scheduling of private flights and management of scheduled flights.

To assist in these and other goals, the present disclosure includes an aviation-based user platform configured to allow for the secure exchange of aviation-based data between travelers, brokers, operators, and owners. For example, the environment for which the aviation-based user platform may be utilized may include one or more traveler devices, one or more broker devices, one or more operator devices, and one or more owner devices. These devices may be any computing devices configured to receive user input and to display information. The environment may also include a remote system, which is remote from one or more of the traveler devices, the broker devices, the operator devices, and the owner devices. The remote system may include one or more components that may allow for use of the aviation-based user platform. For example, the remote system may include one or more user interfaces that may be configured for display on one or more of the traveler devices, the broker devices, the operator devices, and/or the owner devices. For example, the user interfaces may include traveler user interfaces that are configured to, among other things, display information associated with potential flights to be scheduled by the traveler. The traveler user interfaces may include a searching element configured to receive user input indicating details of a flight a traveler wishes to search for, such as for scheduling purposes. The user input may include, for example, a departure time, a departure location, a length of desired use, an arrival location, an aerial vehicle type, desired aerial vehicle attributes, a number of travelers, desired amenities, etc. The traveler user interfaces may also include a results element that may be configured to display results of the searches described herein. The traveler user interfaces may also include a saved flights element configured to display scheduled flights associated with the traveler and/or an action element configured to allow the user to provide user input for the aviation-based platform to perform one or more actions, such as editing a user profile associated with the traveler, editing user preferences, editing proxy authorization status, messaging services, etc.

The traveler user interfaces may also allow the traveler to search for one or more flight brokers to assist with the booking of a private flight. For example, the aviation-based user platform may allow for flight brokers to utilize the aviation-based user platform to generate a web page or other web-based location specific to a given broker where travelers can navigate to for scheduling flights and/or for obtaining private flight information. The aviation-based user platform may query the brokers for information associated with the brokers, such as operators that they are affiliated with, web page preferences, contact information, messaging preferences, auto-booking functionality enablement, etc. The aviation-based user platform may utilize some or all of this information to generate web pages for the flight brokers. Each of the web pages may be at least partially unique to the given flight broker and the web pages may be accessible to the flight broker and travelers. The flight broker web pages may display information associated with available flights offered by the flight broker as well as functionality for travelers to contact the flight brokers, such as by secure messaging.

The travelers may utilize the flight broker web pages to initiate the scheduling of a private flight. The travelers may select a displayed available flight and/or the travelers may provide user input to search for available flights. When search functionality is utilized, a request component of the remote system may receive user input data representing the search query, and may perform a search for available flights that correspond to or correspond most closely to the details of the search query. If the traveler selects a flight associated with the broker, the broker web page may cause a user interface to be displayed that is configured to receive additional user input for scheduling the selected flight. The broker web pages may be updated dynamically based at least in part on flight availabilities, operator associations, owner associations, aerial vehicle availability, crew availability, and/or changes to user preferences. In this way, a traveler looking to book a private flight may be presented with the most up-to-date, accurate options for selecting a private flight without the need for the broker and multiple operators to communicate in an extended booking arrangement.

Once an available flight is selected, a scheduling component of the remote system may be configured to generate data for scheduling the flight. The flight scheduling data may associate an identifier of the traveler with an identifier for the flight and may indicate that the flight is no longer available for selection by another traveler. Also, given that the aviation-based user platform is associated with private flights, the flight scheduling data may include a duration of time and/or time range when the aerial vehicle is not available for scheduling even when the aerial vehicle is not physically in the air. The flight scheduling data may also include other information about the flight, such as the flight broker associated with scheduling the flight, other travelers indicated to be on the flight, the operator of the flight, the owner of the aerial vehicle, the crew scheduled for the flight, the departure location of the flight, and/or any other data associated with the scheduled flight.

In examples, an anonymizer of the remote system may be configured to anonymize at least a portion of the data associated with the scheduled flight. For example, certain data may be anonymized for viewing by certain entities. By way of example, the owner of the aerial vehicle may be anonymized or otherwise not made available to the traveler, but instead an anonymized identifier may be provided. Likewise, the identities of travelers may be anonymized for display to owners and/or operators. In this way, the remote system may be configured to identify data that has been predesignated as a sensitive data type and may anonymize that data when display of that data is requested by certain entities. This may allow for the secure exchange of information for scheduling a flight without display of sensitive information to entities that do not need that information for flight scheduling.

Additionally, a price component of the remote system may be configured to analyze pricing data associated with available flights on the aviation-based user platform to provide price recommendations to operators, owners, and/or brokers. For example, an operator and/or owner may desire to offer a private flight for an amount that a traveler is willing to pay without underpricing or overpricing the flight. However, given the disparate nature of private flights across owners and operators, such entities may have little insight on what a reasonable price might be. The price component may be configured as a model, such as a machine learning model is certain examples, that receives as input pricing data for other available flights on the aviation-based user platform as well as attributes associated with those flights, such as aerial vehicle type, crew ratings, departure location, length of flight, operator ratings, number of travelers that can be associated with the flight, etc. The price component may then, for a given flight, compare flight attributes to determine other flights that correspond to or most closely correspond to the flight attributes of the other flights that have been scheduled. The price component may then utilize the pricing data associated with those other flights to determine a recommended price to offer the given flight for. Recommendation data indicating the recommendation may be sent to devices associated with the operator(s) and/or owner(s) along with a request to associate the recommended price with the given flight. The operator(s) and/or owner(s) may provide user input to either confirm or reject the recommended price, and the price may be updated accordingly. Additionally, or alternatively, particularly when user preference data indicates authorization to do so, the price associated with a given flight may be automatically updated by the aviation-based user platform without user input when a price recommendation is generated. This may allow for the dynamic, time-sensitive changing of flight prices without the need to wait for the operator(s) and/or owner(s) to provide user input.

A tracking component of the remote system may be configured to track the location of one or more devices and/or aerial vehicles associated with a scheduled flight. For example, when a flight is scheduled, data indicating devices associated with crew from the flight as well as an identifier of the aerial vehicle may be associated with the flight scheduling data. Additionally, data indicating devices associated with travelers may also be associated with the flight scheduling data. The tracking component, when authorized to do so by users associated with the aviation-based user platform, may track the geolocation of the devices within certain time ranges associated with the flight. For example, if the flight is scheduled to depart at a given time, the tracking component may track one or more of the devices within a threshold amount of time from the given time the flight is scheduled to depart. The tracking component may be configured to compare the location of a given device with one or more distance thresholds to determine if the devices are likely to be at the departure location at a scheduled time. In examples, where the location of a given device does not satisfy the distance thresholds, one or more corrective actions may be taken. For example, if the tracking component determines that a device associated with a given crew member assigned to the flight is outside the distance threshold and therefore is unlikely to arrive at the departure location with enough time for the flight to depart on time, the tracking component may attempt to identify an alternate crew member for the flight. These operations may be performed with respect to other crew members, services associated with the flight such as catering, the location of the aerial vehicle itself, and/or other travelers. The tracking component may be configured to utilize contextual data when making the determinations described herein, such as weather data, traffic data, event data, calendar and/or scheduling data, etc. An update component of the remote system may be utilized to update the flight scheduling data to account for any changes associated with the results of the tracking component.

A notification component of the remote system may be configured to generate and send notifications to one or more devices associated with a scheduled flight. For example, when the flight is scheduled, the notification component may generate and send confirmation information to devices associated with the traveler(s), the broker, the operator, and/or the owner. Additionally, when changes to the flight scheduling data occur, the notification component may be configured to generate and send notifications to one or more of the devices described herein indicating the change.

Additionally, or alternatively, the aviation-based user platform may be configured to preemptively identify “empty leg” flights. These empty leg flights may correspond to unbooked flights that the operators and/or owners wish to book but that might not necessarily be presented as results to a search query by a traveler. Booking empty leg flights may be advantageous to travelers because those flights may be offered at a discounted rate. To do so, a flight identifier of the remote system may identify one or more flights that are frequently unscheduled and/or situations where an aerial vehicle was utilized for a one-way flight and the operator and/or owner desires to have the aerial vehicle travel back to the original departure location. In these and other examples of unscheduled flights, the flight identifier may identify the flight and generate availability data indicating details of the unscheduled flights. The price component and/or the operator and/or owner may determine a price to associate with the unscheduled flight, and such unscheduled flights may be displayed, such as on the broker web pages and/or the traveler user interfaces. In examples, identifiers of the unscheduled flights may be displayed based at least in part on a traveler request to display such information, based at least in part on a potential departure location of a traveler, based at least in part on a geolocation of a traveler device, based at least in part on historical flight data, and/or based at least in part on user preferences of travelers and/or brokers.

A proxy component of the remote system may be configured to authorize the use of proxies for flight scheduling. For example, a given traveler may desire to authorize one or more other people to schedule flights for the traveler such that the traveler does not need to schedule flights for her/himself. To do so, the proxy component may be configured to display one or more proxy authorization options for the traveler. The proxy authorization options may include an identifier of a user profile and/or person identifier to which the traveler would like to associate with as a proxy as well as a degree of authorization allowed by the traveler. The degree of authorization may include full authorization to search for, schedule, and change flights, and/or the degree of authorization may include one or more limits on the ability of the proxy to search for, schedule, and change flights. The proxy authorization options may also include notification preferences when the proxy authorizes a flight on behalf of the traveler. Once the proxy authorization options are set, the proxy may utilize the proxy's user profile to search for, schedule, and change flights on behalf of the traveler.

A payment component of the aviation-based user platform may be configured to assist in transferring funds between entities associated with the aviation-based user platform. For example, when a flight is scheduled, and/or at another time associated with the scheduled flight, the aviation-based user platform may be configured to receive payment information from the one or more travelers. Funds for the scheduled flight may be received from an account of the traveler(s) and stored in an account associated with the aviation-based user platform. Thereafter, such as when a trigger event occurs, which may be for example when the flight departs and/or is completed, the aviation-based user platform may be configured to transfer funds to accounts associated with the broker, the operator, and/or the owner associated with the flight. To do so, the payment component may be configured to use user data associated with the various entities to determine which portion of the funds is to be transferred to each entity, such as based on arrangements between entities and/or default pricing rules associated with the aviation-based user platform. In this way, each of the entities associated with a flight may be paid using the aviation-based user platform, which may allow for timely and secure payment that is recordable and tracible.

A messaging component of the remote system may be configured to enable messaging between entities associated with a given flight. For example, the flight scheduling data described elsewhere herein may include identifiers of devices associated with travelers, brokers, operators, owners, crew, and/or other personnel associated with a given flight. The messaging component may be configured to authorize messaging between such devices in association with the flight. The messaging component may also be configured to restrict messaging between two or more of these devices when those devices are not associated with the flight, such as after the flight has been completed. Additionally, identities of people associated with the devices may not be shared during messaging, instead opting for entity type identifiers such as “pilot,” “staff member,” “broker,” and/or “traveler” for example. Additionally, the contact information associated with the devices may not be shared. In this way, the aviation-based user platform may allow for messaging to occur amongst devices associated with a flight in a secure manner and without any individual obtain information that could be used to identify and/or contact other individuals outside of the scheduled flight. Messages may also be kept separate from other messages associated with the same flight. For example, messages between two travelers may not be shared with other entities such as brokers, pilots, operators, etc. unless requested to do so by the travelers.

A manifest component of the remote system may be configured to generate flight manifest data for a given flight. For example, during the booking process, the booking traveler and/or a proxy may be asked to provide information for all travelers for the flight. The booking traveler and/or proxy may provide identifying information for the booking traveler as well as an identifier for other travelers and contact information for those travelers. The manifest component may utilize the contact information for the other travelers to send a request for information to those travelers. The request may include instructions for accessing the aviation-based platform for providing identifying information for the travelers and/or may enable the travelers to provide information for generating a user profile for the travelers. Once this data is received from the other travelers, the manifest component may be utilized to generate a flight manifest for the flight. The flight manifest may identify the travelers and at least a portion of identifying information about the travelers. The manifest may also include user preferences associated with the travelers, traveler restrictions and/or requests, and/or other data that may be required or desired for allowing the travelers to travel on the flight. The flight manifest data may be stored in one or more database of the aviation-based user platform and may be accessible to those entities that may require the flight manifest data, such as the operator, pilot, etc.

An auto-booking component of the remote system may be configured to enable and utilize auto-booking functionality for booking one or more flights. For example, a given operator and/or owner may provide user input to the aviation-based user platform indicating a desire to utilize auto-booking functionality, as opposed to receiving a request to book a flight and then needing to respond to confirm booking. The aviation-based user platform may receive the user input data and enable auto-booking functionality for a given flight, a given operator, a given owner, and/or a given aerial vehicle depending on what was indicated by the user input data. Once enabled, when a traveler desires to book a flight associated with the auto-booking functionality, the traveler may utilize the broker web pages as described herein to select and book the flight without any confirmation input needed from the broker, operator, and/or owner. Given the disparate nature of private aviation, the auto-booking functionality may be user configurable down to a range of times, days, departure locations, traveler types (such as based on traveler ratings), and/or any other attributes of any entity and/or of a given flight at issue.

Additionally, or alternatively, the aviation-based user platform may include an insurance component. The insurance component may be configured to offer and/or provide insurance associated with flights scheduled utilizing the aviation-based user platform. For example, during or after booking a flight, the aviation-based user platform may be configured to determine insurance terms associated with an insurance policy to be offered to a traveler and/or to other entities involved in the flight. If accepted, the insurance policy may insure against one or more events occurring that would result in loss to one or more of the entities. For example, the insurance policies may cover expenses and/or costs associated with lost luggage, flight delays, flight cancellation, fuel overages, and/or costs associated with emergency services, such as when the flight is an air ambulance. The aviation-based user platform may provide the insurance policies and/or may allow one or more third-party insurance providers to utilize the aviation-based user platform for providing insurance.

The present disclosure provides an overall understanding of the principles of the structure, function, manufacture, and use of the systems and methods disclosed herein. One or more examples of the present disclosure are illustrated in the accompanying drawings. Those of ordinary skill in the art will understand that the systems and methods specifically described herein and illustrated in the accompanying drawings are non-limiting embodiments. The features illustrated or described in connection with one embodiment may be combined with the features of other embodiments, including as between systems and methods. Such modifications and variations are intended to be included within the scope of the appended claims.

Additional details are described below with reference to several example embodiments.

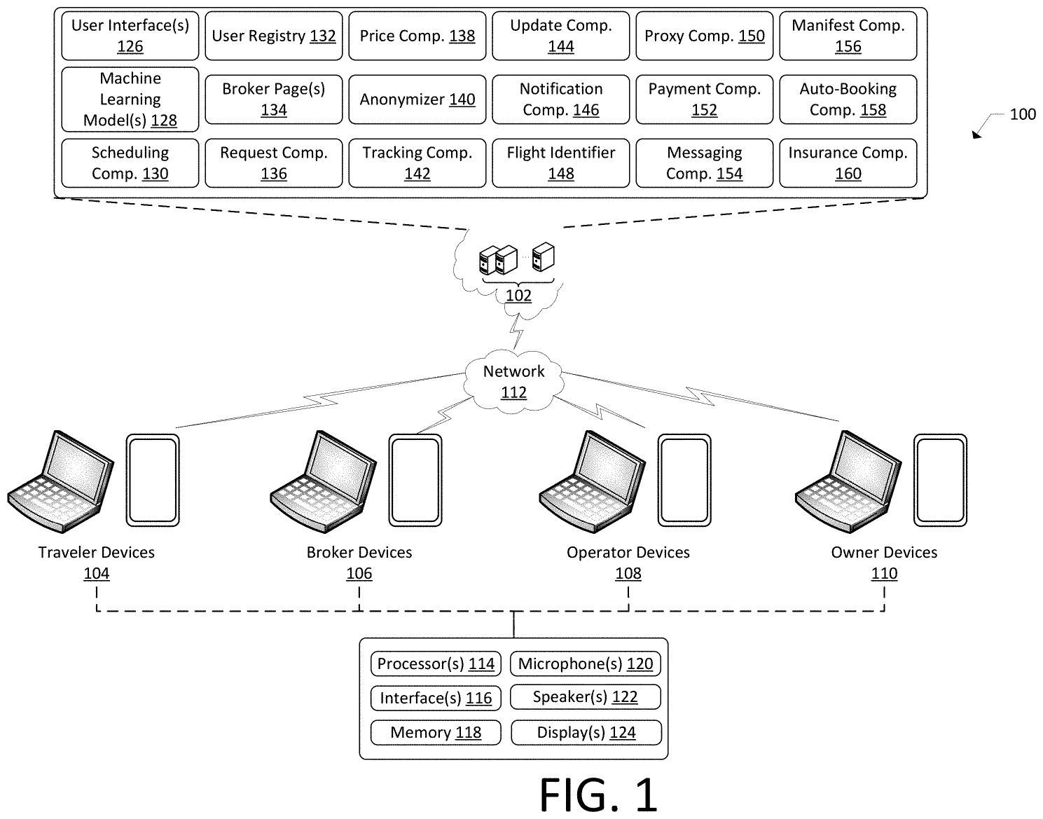

FIG. 1 illustrates a schematic diagram of an example system 100 for aviation-based user platforms. The system 100 may include, for example, a remote system 102 associated with the aviation-based user platform, traveler devices 104, broker devices 106, operator devices 108, and/or owner devices 110. Each of these devices may include any computing devices configured to receive data from one or more of the other devices and/or the remote system 102 and/or to send data from one or more of the other devices and/or the remote system 102, such as via a network 112.

It should be understood that where operations are described herein as being performed by the remote system 104, some or all of those operations may be performed by the electronic device 102. It should also be understood that anytime the remote system 102 is referenced, that system may include any system and/or device, whether local to an environment of the devices 104, 106, 108, 110 or remote from that environment. Additionally, it should be understood that a given space and/or environment may include numerous devices 104, 106, 108, 110. It should also be understood that when a “space” or “environment” is used herein, those terms mean an area and not necessarily a given room, building, or other structure, unless otherwise specifically described as such.

One or more of the traveler devices 104, broker devices 106, operator devices 108, and/or owner devices 110 may include one or more components such as one or more processors 114, one or more network interfaces 116, memory 118, one or more microphones 120, one or more speakers 122, and/or one or more displays 124. The microphones 120 may be configured to receive audio from an environment associated with one or more of the devices 104, 106, 108, 110 and generate corresponding audio data. The speakers 122 may be configured to receive audio data and output corresponding audio. The displays 124 may be configured to display information as will be described more fully herein.

The remote system 102 may include components such as, for example, one or more user interfaces 126, one or more machine learning models 128, a scheduling component 130, a user registry 132, one or more broker pages 134, a request component 136, a price component 138, an anonymizer 140, a tracking component 142, an update component 144, a notification component 146, a flight identifier 148, a proxy component 150, a payment component 152, a messaging component 154, a manifest component 156, an auto-booking component 158, and/or an insurance component 160. It should be understood that while the components of the remote system 102 are depicted and/or described as separate from each other in FIG. 1, some or all of the components may be a part of the same system. It should also be understood that the remote system 102 may include one or more processors, one or more network interfaces, and memory that stores the components described herein. Each of the components of the remote system 102 will be described in more detail below by way of example.

For example, the aviation-based user platform may configured to allow for the secure exchange of aviation-based data between travelers, brokers, operators, and owners. For example, the user interfaces 126 that may be configured for display on one or more of the traveler devices 104, the broker devices 106, the operator device 108, and/or the owner devices 110. For example, the user interfaces 126 may include traveler user interfaces 126 that are configured to, among other things, display information associated with potential flights to be scheduled by the traveler. The traveler user interfaces 126 may include a searching element configured to receive user input indicating details of a flight a traveler wishes to search for, such as for scheduling purposes. The user input may include, for example, a departure time, a departure location, a length of desired use, an arrival location, an aerial vehicle type, desired aerial vehicle attributes, a number of travelers, desired amenities, etc. The traveler user interfaces 126 may also include a results element that may be configured to display results of the searches described herein. The traveler user interfaces 126 may also include a saved flights element configured to display scheduled flights associated with the traveler and/or an action element configured to allow the user to provide user input for the aviation-based user platform to perform one or more actions, such as editing a user profile associated with the traveler, editing user preferences, editing proxy authorization status, messaging services, etc.

The traveler user interfaces 126 may also allow the traveler to search for one or more flight brokers to assist with the booking of a private flight. For example, the aviation-based user platform may allow for flight brokers to utilize the aviation-based user platform to generate the broker web pages 134 or other web-based location specific to a given broker where travelers can navigate to for scheduling flights and/or for obtaining private flight information. The aviation-based user platform may query the brokers for information associated with the brokers, such as operators that they are affiliated with, web page preferences, contact information, messaging preferences, auto-booking functionality enablement, etc. The aviation-based user platform may utilize some or all of this information to generate web pages 134 for the flight brokers. Each of the web pages 134 may be at least partially unique to the given flight broker and the web pages 134 may be accessible to the flight broker and travelers. The flight broker web pages may display information associated with available flights offered by the flight broker as well as functionality for travelers to contact the flight brokers, such as by secure messaging.

The travelers may utilize the flight broker web pages 134 to initiate the scheduling of a private flight. The travelers may select a displayed available flight and/or the travelers may provide user input to search for available flights. When search functionality is utilized, the request component 136 may receive user input data representing the search query, and may perform a search for available flights that correspond to or correspond most closely to the details of the search query. If the traveler selects a flight associated with the broker, the broker web page 134 may cause a user interface 126 to be displayed that is configured to receive additional user input for scheduling the selected flight. The broker web pages 134 may be updated dynamically based at least in part on flight availabilities, operator associations, owner associations, aerial vehicle availability, crew availability, and/or changes to user preferences. In this way, a traveler looking to book a private flight may be presented with the most up-to-date, accurate options for selecting a private flight without the need for the broker and multiple operators to communicate in an extended booking arrangement.

Once an available flight is selected, the scheduling component 130 may be configured to generate data for scheduling the flight. The flight scheduling data may associate an identifier of the traveler with an identifier for the flight and may indicate that the flight is no longer available for selection by another traveler. Also, given that the aviation-based user platform is associated with private flights, the flight scheduling data may include a duration of time and/or time range when the aerial vehicle is not available for scheduling even when the aerial vehicle is not physically in the air. The flight scheduling data may also include other information about the flight, such as the flight broker associated with scheduling the flight, other travelers indicated to be on the flight, the operator of the flight, the owner of the aerial vehicle, the crew scheduled for the flight, the departure location of the flight, and/or any other data associated with the scheduled flight.

In examples, the anonymizer 140 may be configured to anonymize at least a portion of the data associated with the scheduled flight. For example, certain data may be anonymized for viewing by certain entities. By way of example, an identifier of the owner of the aerial vehicle may be anonymized or otherwise not made available to the traveler, but instead an anonymized identifier may be provided. Likewise, the identities of travelers may be anonymized for display to owners and/or operators. In this way, the remote system 102 may be configured to identify data that has been predesignated as a sensitive data type and may anonymize that data when display of that data is requested by certain entities. This may allow for the secure exchange of information for scheduling a flight without display of sensitive information to entities that do not need that information for flight scheduling.

Additionally, the price component 138 may be configured to analyze pricing data associated with flights on the aviation-based user platform to provide price recommendations to operators, owners, and/or brokers. For example, an operator and/or owner may desire to offer a private flight for an amount that a traveler is willing to pay without underpricing or overpricing the flight. However, given the disparate nature of private flights across owners and operators, such entities may have little insight on what a reasonable price might be. The price component 138 may be configured as a model, such as a machine learning model in certain examples, that receives as input pricing data for other available flights on the aviation-based user platform as well as attributes associated with those flights, such as aerial vehicle type, crew ratings, departure location, length of flight, operator ratings, number of travelers that can be associated with the flight, etc. The price component 138 may then, for a given flight, compare flight attributes to determine other flights that correspond to or most closely correspond to the flight attributes of the other flights that have been scheduled. The price component 138 may then utilize the pricing data associated with those other flights to determine a recommended price to offer the given flight for. Recommendation data indicating the recommendation may be sent to devices associated with the operator(s) and/or owner(s) along with a request to associate the recommended price with the given flight. The operator(s) and/or owner(s) may provide user input to either confirm or reject the recommended price, and the price may be updated accordingly. Additionally, or alternatively, particularly when user preference data indicates authorization to do so, the price associated with a given flight may be automatically updated by the aviation-based user platform without user input when a price recommendation is generated. This may allow for the dynamic, time-sensitive changing of flight prices without the need to wait for the operator(s) and/or owner(s) to provide user input.

The machine learning models 128 as described herein may include predictive analytic techniques, which may include, for example, predictive modelling, machine learning, and/or data mining. Generally, predictive modelling may utilize statistics to predict outcomes. Machine learning, while also utilizing statistical techniques, may provide the ability to improve outcome prediction performance without being explicitly programmed to do so. A number of machine learning techniques may be employed to generate and/or modify the models describes herein. Those techniques may include, for example, decision tree learning, association rule learning, artificial neural networks (including, in examples, deep learning), inductive logic programming, support vector machines, clustering, Bayesian networks, reinforcement learning, representation learning, similarity and metric learning, sparse dictionary learning, and/or rules-based machine learning.

Information from stored and/or accessible data may be extracted from one or more databases and may be utilized to predict trends and behavior patterns. In examples, the event, otherwise described herein as an outcome, may be an event that will occur in the future, such as whether presence will be detected. The predictive analytic techniques may be utilized to determine associations and/or relationships between explanatory variables and predicted variables from past occurrences and utilizing these variables to predict the unknown outcome. The predictive analytic techniques may include defining the outcome and data sets used to predict the outcome. Then, data may be collected and/or accessed to be used for analysis.

Data analysis may include using one or more models, including for example one or more algorithms, to inspect the data with the goal of identifying useful information and arriving at one or more determinations that assist in predicting the outcome of interest. One or more validation operations may be performed, such as using statistical analysis techniques, to validate accuracy of the models. Thereafter, predictive modelling may be performed to generate accurate predictive models for future events. Outcome prediction may be deterministic such that the outcome is determined to occur or not occur. Additionally, or alternatively, the outcome prediction may be probabilistic such that the outcome is determined to occur to a certain probability and/or confidence.

The tracking component 142 may be configured to track the location of one or more devices and/or aerial vehicles associated with a scheduled flight. For example, when a flight is scheduled, data indicating devices associated with crew from the flight as well as an identifier of the aerial vehicle may be associated with the flight scheduling data. Additionally, data indicating devices associated with travelers may also be associated with the flight scheduling data. The tracking component 142, when authorized to do so by users associated with the aviation-based user platform, may track the geolocation of the devices within certain time ranges associated with the flight. For example, if the flight is scheduled to depart at a given time, the tracking component 142 may track one or more of the devices within a threshold amount of time from the given time the flight is scheduled to depart. The tracking component 142 may be configured to compare the location of a given device with one or more distance thresholds to determine if the devices are likely to be at the departure location at the scheduled departure time. In examples, where the location of a given device does not satisfy the distance thresholds, one or more corrective actions may be taken. For example, if the tracking component 142 determines that a device associated with a given crew member assigned to the flight is outside the distance threshold and therefore is unlikely to arrive at the departure location with enough time for the flight to depart on time, the tracking component 142 may attempt to identify an alternate crew member for the flight. These operations may be performed with respect to other crew members, services associated with the flight such as catering, the location of the aerial vehicle itself, and/or other travelers, for example. The tracking component 142 may be configured to utilize contextual data when making the determinations described herein, such as weather data, traffic data, event data, calendar and/or scheduling data, etc. The update component 144 may be utilized to update the flight scheduling data to account for any changes associated with the results of the tracking component 144. The update component 144 may also be configured to update any data described herein when one or more other components of the remote system 102 determine a change associated with a flight, the aviation-based user platform, and/or one or more of the entities described herein.

The notification component 146 may be configured to generate and send notifications to one or more devices associated with a scheduled flight. For example, when the flight is scheduled, the notification component 146 may generate and send confirmation information to devices associated with the traveler(s), the broker, the operator, and/or the owner. Additionally, when changes to the flight scheduling data occur, the notification component 146 may be configured to generate and send notifications to one or more of the devices 104, 106, 108, 110 described herein indicating the change.

Additionally, or alternatively, the aviation-based user platform may be configured to preemptively identify “empty leg” flights. These empty leg flights may correspond to unbooked flights that the operators and/or owners wish to book but that might not necessarily be presented as results to a search query by a traveler. Booking empty leg flights may be advantageous to travelers because those flights may be offered at a discounted rate. To do so, the flight identifier 148 may identify one or more flights that are frequently unscheduled and/or situations where an aerial vehicle was utilized for a one-way flight and the operator and/or owner desires to have the aerial vehicle travel back to the original departure location. In these and other examples of unscheduled flights, the flight identifier may identify the flight and generate availability data indicating details of the unscheduled flight. The price component 138 and/or the operator and/or owner may determine a price to associate with the unscheduled flight, and such unscheduled flights may be displayed, such as on the broker web pages 134 and/or the traveler user interfaces 126. In examples, identifiers of the unscheduled flights may be displayed based at least in part on a traveler request to display such information, based at least in part on a potential departure location of a traveler, based at least in part on a geolocation of a traveler device, based at least in part on historical flight data, and/or based at least in part on user preferences of travelers and/or brokers.

The proxy component 150 may be configured to authorize the use of proxies for flight scheduling. For example, a given traveler may desire to authorize one or more other people to schedule flights for the traveler such that the traveler does not need to schedule flights for her/himself. To do so, the proxy component 150 may be configured to display one or more proxy authorization options for the traveler. The proxy authorization options may include an identifier of a user profile and/or person identifier to which the traveler would like to associate with as a proxy as well as a degree of authorization allowed by the traveler. The degree of authorization may include full authorization to search for, schedule, and change flights, and/or the degree of authorization may include one or more limits on the ability of the proxy to search for, schedule, and change flights. The proxy authorization options may also include notification preferences when the proxy authorizes a flight on behalf of the traveler. Once the proxy authorization options are set, the proxy may utilize the proxy's user profile to search for, schedule, and change flights on behalf of the traveler.

The user registry 132 as described herein may store data associated with one or more user profiles and/or user accounts associated with users of the aviation-based user platform. One or more of the entities that interact with the aviation-based user platform may be associated with a user profile and/or user account. The user profiles and/or user accounts may store data associated with the entities, including for example user preference data, device identifier data, historical use data, geographic location data, flight scheduling data, prior flight data, and/or any other data associated with the entities use of the aviation-based user platform.

The payment component 152 may be configured to assist in transferring funds between entities associated with the aviation-based user platform. For example, when a flight is scheduled, and/or at another time associated with the scheduled flight, the aviation-based user platform may be configured to receive payment information from the one or more travelers. Funds for the scheduled flight may be received from an account of the traveler(s) and stored in an account associated with the aviation-based user platform. Thereafter, such as when a trigger event occurs, which may be for example when the flight departs and/or is completed, the payment component 152 may be configured to transfer funds to accounts associated with the broker, the operator, and/or the owner associated with the flight. To do so, the payment component 152 may be configured to use user data associated with the various entities to determine which portion of the funds is to be transferred to each entity, such as based on arrangements between entities and/or default pricing rules associated with the aviation-based user platform. In this way, each of the entities associated with a flight may be paid using the aviation-based user platform, which may allow for timely and secure payment that is recordable and tracible.

The messaging component 154 may be configured to enable messaging between entities associated with a given flight. For example, the flight scheduling data described elsewhere herein may include identifiers of devices associated with travelers, brokers, operators, owners, crew, and/or other personnel associated with a given flight. The messaging component 154 may be configured to authorize messaging between such devices in association with the flight. The messaging component 154 may also be configured to restrict messaging between two or more of these devices when those devices are not associated with the flight, such as after the flight has been completed. Additionally, identities of people associated with the devices may not be shared during messaging, instead opting for entity type identifiers such as “pilot,” “staff member,” “broker,” and/or “traveler” for example. Additionally, the contact information associated with the devices may not be shared. In this way, the aviation-based user platform may allow for messaging to occur amongst devices associated with a flight in a secure manner and without any individual obtaining information that could be used to identify and/or contact other individuals outside of the scheduled flight. Messages may also be kept separate from other messages associated with the same flight. For example, messages between two travelers may not be shared with other entities such as brokers, pilots, operators, etc. unless requested to do so by the travelers.

The manifest component 156 may be configured to generate flight manifest data for a given flight. For example, during the booking process, the booking traveler and/or a proxy may be asked to provide information for all travelers for the flight. The booking traveler and/or proxy may provide identifying information for the booking traveler as well as an identifier for other travelers and contact information for those travelers. The manifest component 156 may utilize the contact information for the other travelers to send a request for information to those travelers. The request may include instructions for accessing the aviation-based platform for providing identifying information for the travelers and/or may enable the travelers to provide information for generating a user profile for the travelers. Once this data is received from the other travelers, the manifest component 156 may be utilized to generate a flight manifest for the flight. The flight manifest may identify the travelers and at least a portion of identifying information about the travelers. The manifest may also include user preferences associated with the travelers, traveler restrictions and/or requests, and/or other data that may be required or desired for allowing the travelers to travel on the flight. The flight manifest data may be stored in one or more database of the aviation-based user platform and may be accessible to those entities that may require the flight manifest data, such as the operator, pilot, etc.

The auto-booking component 158 may be configured to enable and utilize auto-booking functionality for booking one or more flights. For example, a given operator and/or owner may provide user input to the aviation-based user platform indicating a desire to utilize auto-booking functionality, as opposed to receiving a request to book a flight and then needing to respond to confirm booking. The aviation-based user platform may receive the user input data and enable auto-booking functionality for a given flight, a given operator, a given owner, and/or a given aerial vehicle depending on what was indicated by the user input data. Once enabled, when a traveler desires to book a flight associated with the auto-booking functionality, the traveler may utilize the broker web pages 134 as described herein to select and book the flight without any confirmation input needed from the broker, operator, and/or owner. Given the disparate nature of private aviation, the auto-booking functionality may be user configurable down to a range of times, days, departure locations, traveler types (such as based on traveler ratings), and/or any other attributes of any entity and/or of a given flight at issue.

The insurance component 160 may be configured to offer and/or provide insurance associated with flights scheduled utilizing the aviation-based user platform. For example, during or after booking a flight, the aviation-based user platform may be configured to determine insurance terms associated with an insurance policy to be offered to a traveler and/or to other entities involved in the flight. If accepted, the insurance policy may insure against one or more events occurring that would result in loss to one or more of the entities. For example, the insurance policies may cover expenses and/or costs associated with lost luggage, flight delays, flight cancellation, fuel overages, and/or costs associated with emergency services, such as when the flight is an air ambulance. The insurance component 160 may provide the insurance policies and/or may allow one or more third-party insurance providers to utilize the aviation-based user platform for providing insurance.

It should be noted that while text data is described as a type of data utilized to communicate between various components of the remote system 102 and/or other systems and/or devices, the components of the remote system 102 may use any suitable format of data to communicate. For example, the data may be in a human-readable format, such as text data formatted as XML, SSML, and/or other markup language, or in a computer-readable format, such as binary, hexadecimal, etc., which may be converted to text data for display by one or more devices such as the devices 104, 106, 108, 110.

As shown in FIG. 1, several of the components of the remote system 102 and the associated functionality of those components as described herein may be performed by one or more of the devices 104, 106, 108, 110. Additionally, or alternatively, some or all of the components and/or functionalities associated with the devices 104, 106, 108, 110 may be performed by the remote system 102.

It should be noted that the exchange of data and/or information as described herein may be performed only in situations where a user has provided consent for the exchange of such information. For example, upon setup of devices and/or initiation of applications, a user may be provided with the opportunity to opt in and/or opt out of data exchanges between devices and/or for performance of the functionalities described herein. Additionally, when one of the devices is associated with a first user account and another of the devices is associated with a second user account, user consent may be obtained before performing some, any, or all of the operations and/or processes described herein. Additionally, the operations performed by the components of the systems described herein may be performed only in situations where a user has provided consent for performance of the operations.

As used herein, a processor, such as processor(s) 114 and/or the processor(s) described with respect to the components of the remote system 102, may include multiple processors and/or a processor having multiple cores. Further, the processors may comprise one or more cores of different types. For example, the processors may include application processor units, graphic processing units, and so forth. In one implementation, the processor may comprise a microcontroller and/or a microprocessor. The processor(s) 114 and/or the processor(s) described with respect to the components of the remote system 102 may include a graphics processing unit (GPU), a microprocessor, a digital signal processor or other processing units or components known in the art. Alternatively, or in addition, the functionally described herein can be performed, at least in part, by one or more hardware logic components. For example, and without limitation, illustrative types of hardware logic components that can be used include field-programmable gate arrays (FPGAs), application-specific integrated circuits (ASICs), application-specific standard products (ASSPs), system-on-a-chip systems (SOCs), complex programmable logic devices (CPLDs), etc. Additionally, each of the processor(s) 114 and/or the processor(s) described with respect to the components of the remote system 102 may possess its own local memory, which also may store program components, program data, and/or one or more operating systems.

The memory 118 and/or the memory described with respect to the components of the remote system 102 may include volatile and nonvolatile memory, removable and non-removable media implemented in any method or technology for storage of information, such as computer-readable instructions, data structures, program component, or other data. Such memory 118 and/or the memory described with respect to the components of the remote system 102 includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, RAID storage systems, or any other medium which can be used to store the desired information and which can be accessed by a computing device. The memory 118 and/or the memory described with respect to the components of the remote system 102 may be implemented as computer-readable storage media (“CRSM”), which may be any available physical media accessible by the processor(s) 114 and/or the processor(s) described with respect to the remote system 102 to execute instructions stored on the memory 118 and/or the memory described with respect to the components of the remote system 102. In one basic implementation, CRSM may include random access memory (“RAM”) and Flash memory. In other implementations, CRSM may include, but is not limited to, read-only memory (“ROM”), electrically erasable programmable read-only memory (“EEPROM”), or any other tangible medium which can be used to store the desired information and which can be accessed by the processor(s).

Further, functional components may be stored in the respective memories, or the same functionality may alternatively be implemented in hardware, firmware, application specific integrated circuits, field programmable gate arrays, or as a system on a chip (SoC). In addition, while not illustrated, each respective memory, such as memory 118 and/or the memory described with respect to the components of the remote system 102, discussed herein may include at least one operating system (OS) component that is configured to manage hardware resource devices such as the network interface(s), the I/O devices of the respective apparatuses, and so forth, and provide various services to applications or components executing on the processors. Such OS component may implement a variant of the FreeBSD operating system as promulgated by the FreeBSD Project; other UNIX or UNIX-like variants; a variation of the Linux operating system as promulgated by Linus Torvalds; the FireOS operating system from Amazon. com Inc. of Seattle, Wash., USA; the Windows operating system from Microsoft Corporation of Redmond, Wash., USA; LynxOS as promulgated by Lynx Software Technologies, Inc. of San Jose, Calif.; Operating System Embedded (Enea OSE) as promulgated by ENEA AB of Sweden; and so forth.

The network interface(s) 116 and/or the network interface(s) described with respect to the components of the remote system 102 may enable messages between the components and/or devices shown in system 100 and/or with one or more other polling systems, as well as other networked devices. Such network interface(s) 116 and/or the network interface(s) described with respect to the components of the remote system 102 may include one or more network interface controllers (NICs) or other types of transceiver devices to send and receive messages over the network 112.

For instance, each of the network interface(s) 116 and/or the network interface(s) described with respect to the components of the remote system 102 may include a personal area network (PAN) component to enable messages over one or more short-range wireless message channels. For instance, the PAN component may enable messages compliant with at least one of the following standards IEEE 802.15.4 (ZigBee), IEEE 802.15.1 (Bluetooth), IEEE 802.11 (WiFi), or any other PAN message protocol. Furthermore, each of the network interface(s) 116 and/or the network interface(s) described with respect to the components of the remote system 102 may include a wide area network (WAN) component to enable message over a wide area network.

In some instances, the remote system 102 may be local to an environment associated the devices 104, 106, 108, 110. For instance, the remote system 102 may be located within one or more of the devices 104, 106, 108, 110. In some instances, some or all of the functionality of the remote system 102 may be performed by one or more of the devices 104, 106, 108, 110. Also, while various components of the remote system 102 have been labeled and named in this disclosure and each component has been described as being configured to cause the processor(s) to perform certain operations, it should be understood that the described operations may be performed by some or all of the components and/or other components not specifically illustrated. It should be understood that, in addition to the above, some or all of the operations described herein may be performed on a phone or other mobile device and/or on a device local to the environment, such as, for example, a hub device.

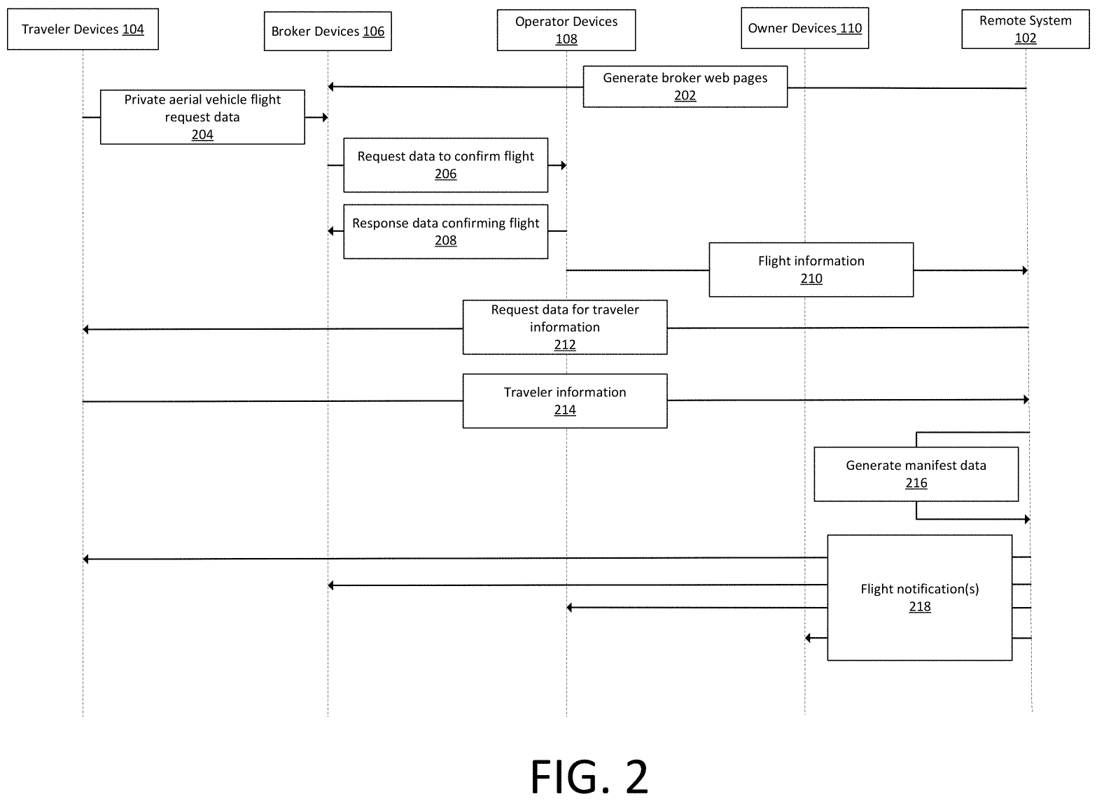

FIG. 2 illustrates a sequence diagram showing an example process associated with an aviation-based user platform. While the sequence diagram depicts the performance of operations and/or the transmission of certain data in a sequential manner, the operations may be performed in a different order than the order depicted in FIG. 2 and/or at least a portion of the operations may be performed in parallel.

At block 202, the remote system 102 may generate broker web pages and be configured to allow for display of the broker web pages on the brokers devices 106. The aviation-based user platform may query the brokers for information associated with the brokers, such as operators that they are affiliated with, web page preferences, contact information, messaging preferences, auto-booking functionality enablement, etc. The aviation-based user platform may utilize some or all of this information to generate web pages for the flight brokers. Each of the web pages may be at least partially unique to the given flight broker and the web pages may be accessible to the flight broker and travelers. The flight broker web pages may display information associated with available flights offered by the flight broker as well as functionality for travelers to contact the flight brokers, such as by secure messaging.

At block 204, the traveler devices 104 may send private aerial vehicle flight request data to the broker devices 106, such as via the remote system 102. The travelers may select a displayed available flight and/or the travelers may provide user input to search for available flights. When search functionality is utilized, a request component of the remote system may receive user input data representing the search query, and may perform a search for available flights that correspond to or correspond most closely to the details of the search query. If the traveler selects a flight associated with the broker, the broker web page may cause a user interface to be displayed that is configured to receive additional user input for scheduling the selected flight. The broker web pages may be updated dynamically based at least in part on flight availabilities, operator associations, owner associations, aerial vehicle availability, crew availability, and/or changes to user preferences. In this way, a traveler looking to book a private flight may be presented with the most up-to-date, accurate options for selecting a private flight without the need for the broker and multiple operators to communicate in an extended booking arrangement.

At block 206, the broker devices 106 may send request data to confirm the flight to the operator devices 108, such as via the remote system 102. For example, a request component of the remote system may generate and send request data to the operator devices 108. The request data may indicate the flight requested to be booked as well as details about the flight. Similar request data may also or alternatively be sent to the owner devices 110. The request data may include functionality, such as a selectable element to be displayed via the operator devices 108, for allowing operator user input to confirm or reject the request to book the flight.

At block 208, the operator devices 108 may send response data confirming the flight to the broker devices 106, such as via the remote system 102. For example, the operator may provide user input to the operator devices 108, which may indicate acceptance or otherwise confirmation for booking the flight. It should be understood that when the flight is associated with auto-booking functionality, the operations described with respect to blocks 206 and 208 may not be performed.

At block 210, the operator devices 108 and/or the broker devices 106 may send flight information associated with the flight to the remote system 102. For example, having confirmed the flight is to be scheduled by the parties involved in the transaction, the remote system 102 may receive the flight information for flight scheduling purposes.

At block 212, the remote system 102 may send request data for traveler information to the traveler devices 104. For example, to finalize booking of the flight, the remote system 102 may request information about the traveler and/or one or more other travelers for the flight. This request data may cause a user interface associated with the traveler devices 104 to display the corresponding request and allow for user input to provide the traveler information. In examples where traveler information for the one or more travelers is already stored or otherwise known to the remote system 102, the operations described with respect to block 212 may be skipped.

At block 214, the traveler devices 104 may send the requested traveler information to the remote system 102. For example, the traveler(s) may provide user input corresponding to the traveler information and corresponding user input data may be sent from the traveler devices 104 to the remote system 102.

At block 216, the remote system 102 may generate flight manifest data. For example, a manifest component of the remote system 102 may be configured to generate flight manifest data for a given flight. For example, during the booking process, the booking traveler and/or a proxy may be asked to provide information for all travelers for the flight. The booking traveler and/or proxy may provide identifying information for the booking traveler as well as an identifier for other travelers and contact information for those travelers. The manifest component may utilize the contact information for the other travelers to send a request for information to those travelers. The request may include instructions for accessing the aviation-based platform for providing identifying information for the travelers and/or may enable the travelers to provide information for generating a user profile for the travelers. Once this data is received from the other travelers, the manifest component may be utilized to generate a flight manifest for the flight. The flight manifest may identify the travelers and at least a portion of identifying information about the travelers. The manifest may also include user preferences associated with the travelers, traveler restrictions and/or requests, and/or other data that may be required or desired for allowing the travelers to travel on the flight. The flight manifest data may be stored in one or more database of the aviation-based user platform and may be accessible to those entities that may require the flight manifest data, such as the operator, pilot, etc.

At block 218, the remote system 102 may send one or more flight notifications to one or more of the traveler devices 104, the broker devices 106, the operator devices 108, and/or the owner devices 110. For example, a notification component may generate and send flight notifications to the devices 104, 106, 108, 110. The notifications may be specific to the entity that is receiving the notification. For example, the notification to the traveler device 104 may indicate that the flight is booked and confirmation information. The notification to the broker device 106 may indicate that the flight is booked and the traveler(s) associated with the flight.

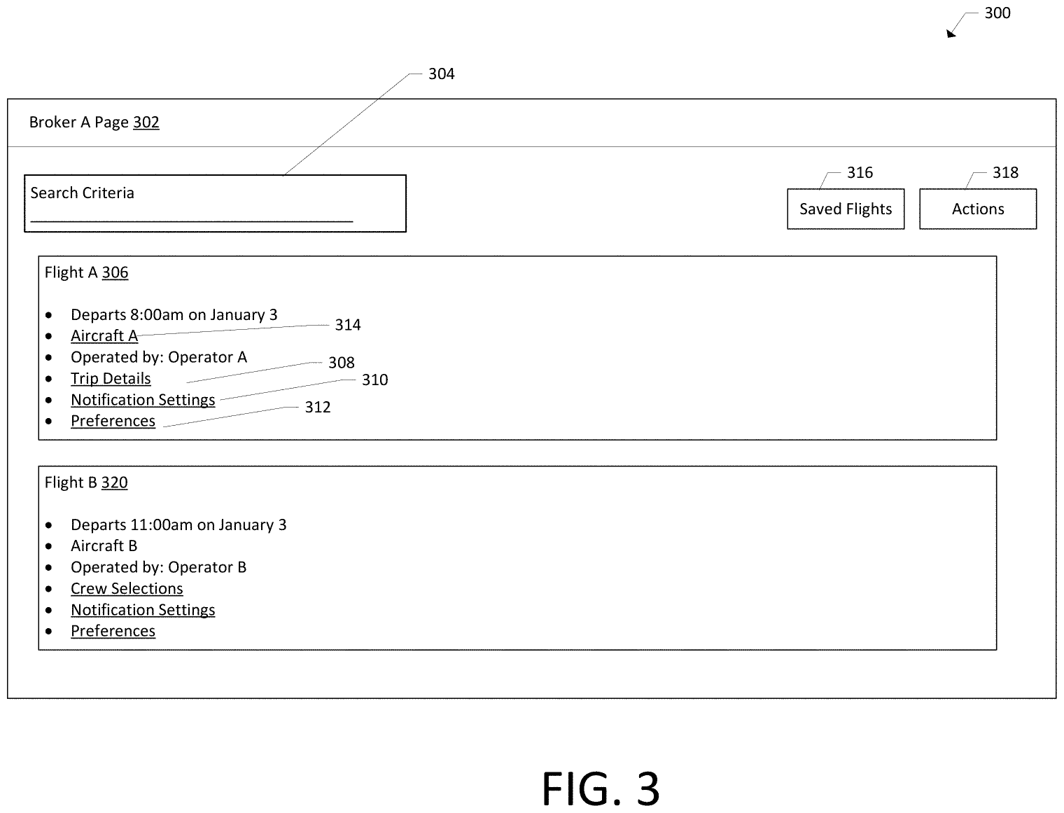

FIG. 3 illustrates an example user interface 300 for use by one or more aerial vehicle travelers associated with an aviation-based user platform. The user interface 300 may be the same or similar to the user interface 126 discussed elsewhere herein.

The user interface 300 shows an example user interface 300 that may be displayed in association with a broker web page 302. For example, the aviation-based user platform may allow for flight brokers to utilize the aviation-based user platform to generate a web page 302 or other web-based location specific to a given broker where travelers can navigate to for scheduling flights and/or for obtaining private flight information. The aviation-based user platform may query the brokers for information associated with the brokers, such as operators that they are affiliated with, web page preferences, contact information, messaging preferences, auto-booking functionality enablement, etc. The aviation-based user platform may utilize some or all of this information to generate web pages 302 for the flight brokers. Each of the web pages 302 may be at least partially unique to the given flight broker and the web pages 302 may be accessible to the flight broker and travelers. The flight broker web pages 302 may display information associated with available flights offered by the flight broker as well as functionality for travelers to contact the flight brokers, such as by secure messaging.

The travelers may utilize the flight broker web pages 302 to initiate the scheduling of a private flight. For example, the user interface 300 may include a search element 304, which may be configured to receive search criteria user input for searching for flights. The travelers may select a displayed available flight and/or the travelers may provide user input to search for available flights. In examples, a traveler may provide user input indicating the departure city for a flight, and the search results may indicate, for example, airports associated with the city, including airports that would not generally be known for public flying. The search results may also include a number of aerial vehicles associated with the airports and/or a number of aerial vehicles that could service the needs of a traveler based on the search criteria entered by the traveler. When search functionality is utilized, a request component of the remote system may receive user input data representing the search query, and may perform a search for available flights that correspond to or correspond most closely to the details of the search query. If the traveler selects a flight associated with the broker, the broker web page 302 may cause the user interface 300 to be displayed that is configured to receive additional user input for scheduling the selected flight. The broker web pages may be updated dynamically based at least in part on flight availabilities, operator associations, owner associations, aerial vehicle availability, crew availability, and/or changes to user preferences. In this way, a traveler looking to book a private flight may be presented with the most up-to-date, accurate options for selecting a private flight without the need for the broker and multiple operators to communicate in an extended booking arrangement.

When search results or otherwise available flight information is displayed via the user interface 300, that flight information may include flight identifiers, such as “Flight A” 306 and “Flight B” 320. It should be understood that one, two, or more flight identifiers may be displayed. The flight information for each flight may also include, by way of example, a departure time, an aerial vehicle identifier, an operator identifier, and/or one or more selectable elements, such as a “trip details” element 308, a “notification settings” element 310, a “preferences” element 312, and/or an “aircraft details” element 314. For example, selection of the trip details element 308 may cause the user interface 300 to display one or more options for viewing and/or deciding on trip details associated with the flight. Selection of the notification settings element 310 may cause the user interface 300 to display one or more options for configuring notifications associated with the flight, such as notification types, notification frequency, which devices to send notifications to, etc. Selection of the preferences element 312 may cause the user interface 300 to display one or more preference options associated with the flight, such as catering options, service options, disability options, etc. Some or all of the options displayed may differ based at least in part on the flight at issue. For example, Flight A 306 may have certain options for selection of crews, preferences, etc., while Flight B 320 may have one or more different options for selection of crews, preferences, etc. Selection of the aircraft details element 314 may cause the user interface 300 to display one or more details associated with the aircraft, including specifications of the aircraft, a schematic and/or diagram of the aircraft, photographs of the aircraft, including photographs taken by previous passengers, etc. Traveler-provided details may also be presented in the user interface 300 and in these examples such details may be user curated and displayed in a way that provides a prospective traveler with information on which to determine which flight to select.

The user interfaces 300 may also include a saved flights element 316 configured to display scheduled flights associated with the traveler and/or an action element 318 configured to allow the user to provide user input for the aviation-based platform to perform one or more actions, such as editing a user profile associated with the traveler, editing user preferences, editing proxy authorization status, messaging services, etc.

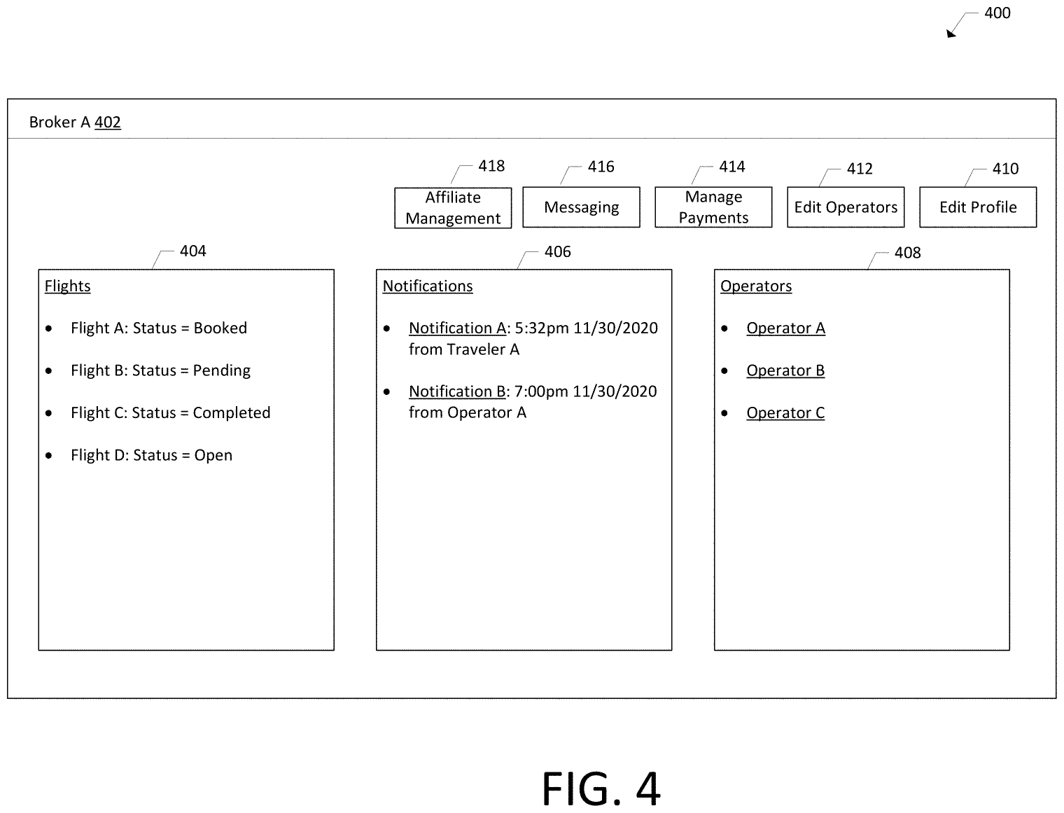

FIG. 4 illustrates an example user interface 400 for use by one or more aerial vehicle flight brokers associated with an aviation-based user platform. The user interface 400 may be the same or similar to the user interface 126 discussed elsewhere herein.

The user interface 400 may be in association with a broker page 402, as discussed in more detail herein. The user interface may include a “flights” screen 404, a notifications screen 406, and/or an “operators” screen 408. The flights screen 404 may include information on the flights associated with a given broker as well as the status of those flights. As shown in FIG. 4, a number of flights, Flights A-D, are listed in the flights screen 404. It should be understood that one, two, three, four, or more flights may be listed. Additionally, the statuses of those flights are listed, such as “booked,” “pending,” “completed,” and “open.” These status designations are provided by way of example only and not as a limitation. The status of a given flight may be any status and that status may be displayed in the flights screen 404. The notifications screen 406 may include notifications associated with the given broker. For example, the notifications shown in FIG. 4 are Notification A and Notification B. It should be understood that one, two, or more than two notifications may be displayed in the notifications screen 406. The substance of the notifications and/or details associated with the notifications may also be displayed in the notifications screen 406. By way of example, the notification details may include a time at which the notification was received, a date at which the notification was received, and/or an identifier of the sender of the notification and/or an identifier of an entity about which the notification pertains. It should be understood that any information associated with a given notification may be displayed in the notifications screen 406. Also, all or a portion of the notifications as displayed in the notifications screen 406 may be selectable, and when selected may cause the substance of the notification to be displayed via the user interface 400.

The operators screen 408 may include a list of one or more operators associated with a given broker. The operators screen 408 may include an identifier of some or all of the operators as well as information associated with the one or more operators. The operator identifiers may be selectable, and when selected may cause the user interface 400 to display additional information about the operators and/or to provide functionality for interactions with operators, such as via operator devices. That functionality may include, by way of example and not as a limitation, the ability to send messages to operators, change information associated with operators, change aerial vehicles and/or owners associated with the operators, etc.

The user interface 400 may also include one or more selectable elements, such as an edit profile element 410, an edit operators element 412, a manage payments element 414, a messaging element 416, and/or an affiliate management element 418. The edit profile element 410 may allow a broker to edit information associated with that broker and/or to edit the broker web page associated with that broker. The edit operators element 412 may allow a broker to add, remove, or change information related to one or more aerial vehicle operators. The management payments element 414 may allow the broker to visualize payments for flights associated with the broker as well as statuses of those payments, and may allow the broker to change account information associated with payments. The messaging element 416 may allow the broker to compose and send one or more messages to travelers, operators, owners, and/or other entities associated with aerial vehicle flights. Details on the sending of messages utilizing the aviation-based user platform are described in more detail elsewhere herein.

The affiliate management element 418 may allow a broker and/or other user to view information and to make selections for affiliate management, such as with respect to other brokers, operators, owners, flight staffing, etc. In this way, the platform may provide brokers with the ability to select how to manage affiliate relationships. This may also provide a user interface 400 for the broker to visualize how affiliate relationships are being managed. Affiliate management, as described herein, may allow for actions to be taken more quickly and/or accurately by the platform, which may result in a more positive user experience for the entities involved in the platform, and particularly for travelers using the platform. This portion of the user interface 400 may also be configured to receive user input for the provision of additional travel-related services to be offered on the platform, including, for example, limousine and/or car rental services, accommodations, etc.

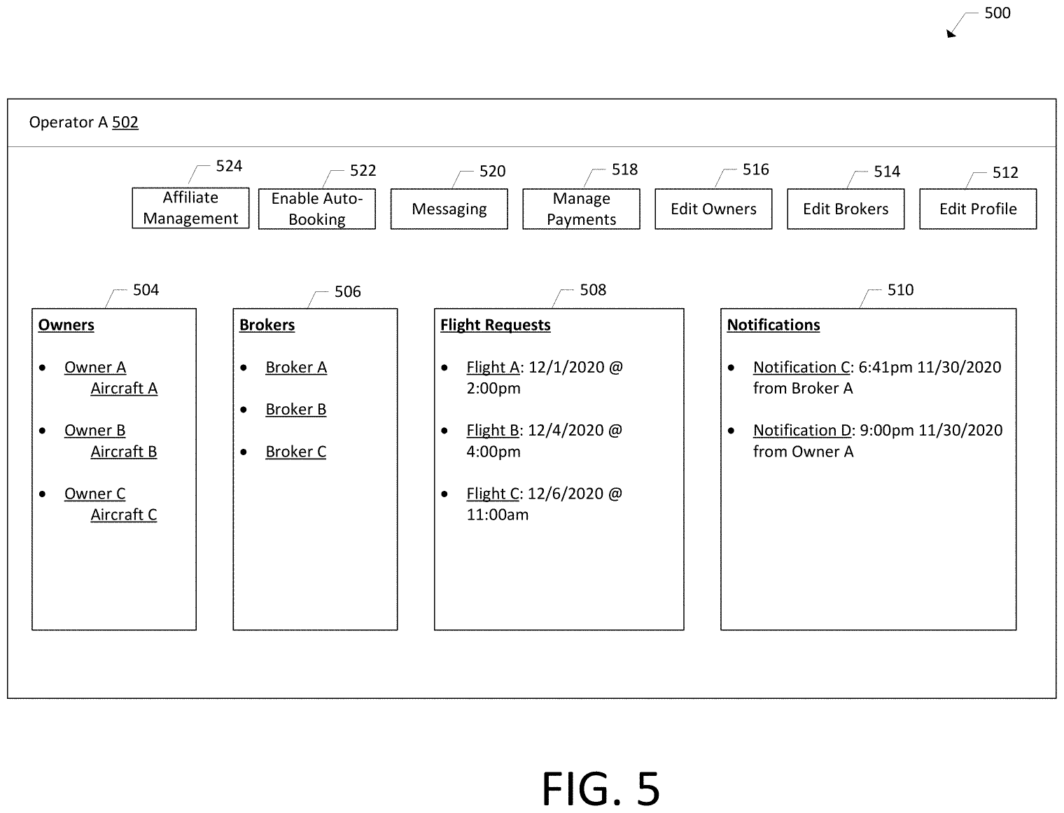

FIG. 5 illustrates an example user interface 500 for use by one or more aerial vehicle operators associated with an aviation-based user platform. The user interface 500 may be the same or similar to the user interface 126 discussed elsewhere herein.

The user interface 500 may include, for example, an operator identifier 502 of the operator at issue, an “owners” screen 504, a “brokers” screen 506, an “flight requests” screen 508, and/or a notifications screen 510. The owners screen 504 may include a list of one or more owners associated with the operator as well as, in examples, an identifier of one or more aerial vehicles associated with that owner. As shown in FIG. 5, Owners A-C and Aircraft A-C are displayed in the owners screen 504. It should be understood that one, two, three, or more than three owner identifiers may be displayed and each owner may be associated with one or more than one aerial vehicle. The owner identifiers and/or aerial vehicle identifiers of the owners screen 504 may be selectable, and when selected may cause the user interface 500 to display additional details about the owners and/or aerial vehicles and may provide functionality for inputting information associated with those owners and/or aerial vehicles.

The brokers screen 506 may include, for example, a list of brokers associated with the operator. As shown in FIG. 5, Brokers A-C are displayed in the brokers screen 506. It should be understood that one, two, three, or more than three broker identifiers may be displayed. The broker identifiers of the brokers screen 506 may be selectable, and when selected may cause the user interface 500 to display additional details about the owners and may provide functionality for inputting information associated with those brokers.

The flight requests screen 508 may include identifiers of flights that a traveler and/or broker has requested to book that are awaiting confirmation by the operator as well as some or all information about the prospective flights. For example, the flight requests screen 508 in FIG. 5 lists Flights A-C. It should be understood that the flight requests screen 508 may list one, two, three, or more flights associated with the operator. The flight information may include, for example and not by way of limitation, a departure time, a departure date, and/or any other information associated with the flight. The flight identifiers of the flight requests screen 508 may be selectable, and when selected may cause the user interface 500 to display additional details about a given flight and/or allow the operator to change or otherwise update the flight information. The user interface 500 may be configured to receive user input data indicating acceptance or rejection of the flight requests, and to schedule flights or notify brokers of rejected flights as described more fully herein. Additionally, the flight information described herein may include information on different flights associated with the same aerial vehicle and/or different aircraft associated with the same flight. For example, a traveler may travel from one location to another location on a first aerial vehicle, but then may travel back to the initial location and/or to another location on a second aerial vehicle. This information may be displayed in the user interface 500. By way of further example, a traveler may travel on a first flight with a given aerial vehicle, but then may fly on a second flight with the same aerial vehicle. This information may be displayed in the user interface 500.

The notifications screen 510 may include notifications associated with the given operator. For example, the notifications shown in FIG. 5 are Notification C and Notification D. It should be understood that one, two, or more than two notifications may be displayed in the notifications screen 510. The substance of the notifications and/or details associated with the notifications may also be displayed in the notifications screen 510. By way of example, the notification details may include a time at which the notification was received, a date at which the notification was received, and/or an identifier of the sender of the notification and/or an identifier of an entity about which the notification pertains. It should be understood that any information associated with a given notification may be displayed in the notifications screen 510. Also, all or a portion of the notifications as displayed in the notifications screen 510 may be selectable, and when selected may cause the substance of the notification to be displayed via the user interface 500.

The user interface 500 may also include one or more selectable elements, such as for example an edit profile element 512, an edit brokers element 514, an edit owners element 516, a manage payments element 518, a messaging element 520, an enable auto-booking element 522, and/or an affiliate management element 524. The edit profile element 512 may allow an operator to edit information associated with that operator. The edit brokers element 514 may allow an operator to add, remove, or change information related to one or more aerial vehicle flight brokers. The management payments element 518 may allow the operator to visualize payments for flights associated with the operator as well as statuses of those payments, and may allow the operator to change account information associated with payments. The messaging element 520 may allow the operator to compose and send one or more messages to travelers, brokers, owners, and/or other entities associated with aerial vehicle flights. Details on the sending of messages utilizing the aviation-based user platform are described in more detail elsewhere herein. The enable auto-booking element 522 may allow the operator to select functionality for enabling auto-booking as described in more detail elsewhere herein.

The affiliate management element 524 may allow an operator and/or other user to view information and to make selections for affiliate management, such as with respect to other operators, brokers, owners, flight staffing, etc. In this way, the platform may provide operators with the ability to select how to manage affiliate relationships. This may also provide a user interface 500 for the operator to visualize how affiliate relationships are being managed. Affiliate management, as described herein, may allow for actions to be taken more quickly and/or accurately by the platform, which may result in a more positive user experience for the entities involved in the platform, and particularly for travelers using the platform. This portion of the user interface 500 may also be configured to receive user input for the provision of additional travel-related services to be offered on the platform, including, for example, limousine and/or car rental services, accommodations, etc.

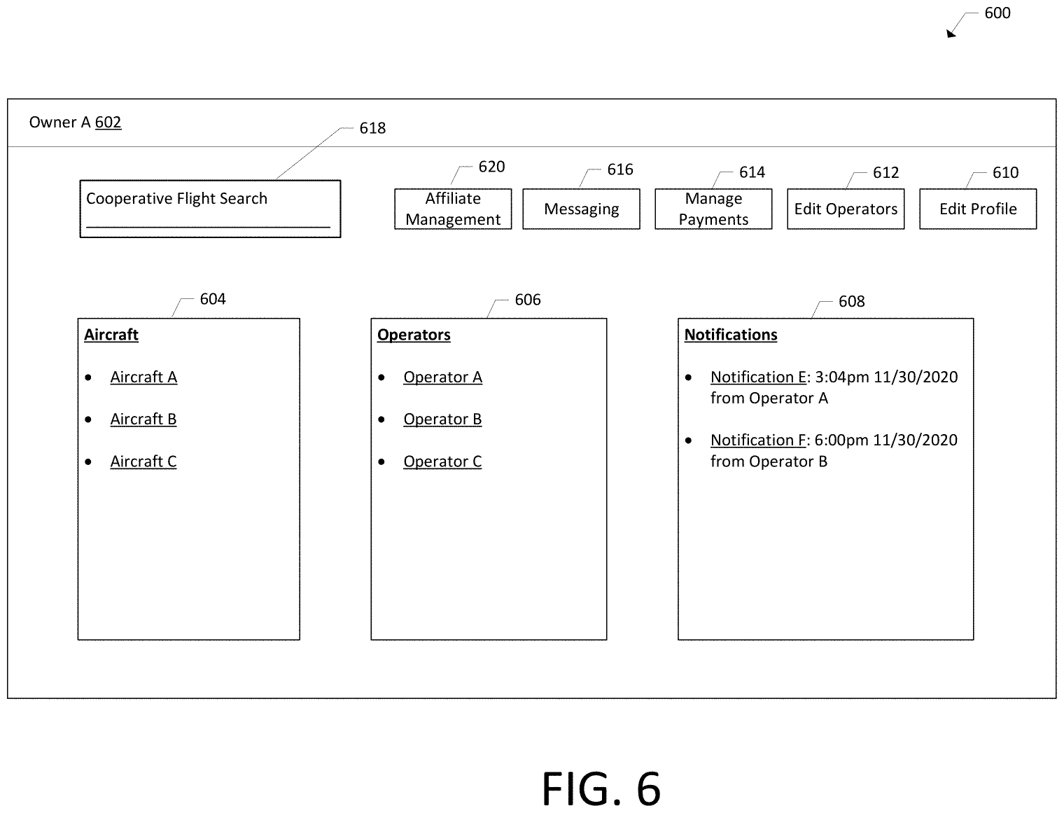

FIG. 6 illustrates an example user interface 600 for use by one or more aerial vehicle owners associated with an aviation-based user platform. The user interface 600 may be the same or similar to the user interface 126 discussed elsewhere herein.

The user interface 600 may include, for example, an owner identifier 602 that identifies a given owner, an “aircraft” screen 604, an “operators” screen 606, and/or a “notifications” screen 608. The aircraft screen 604 may include identifiers of one or more aircraft associated with the owner. Each of the identifiers of the aircraft may be selectable, and when selected may cause additional details associated with the aircraft to be presented on the user interface 600. The owner may be enabled to add, remove, or change details associated with the aircraft, add new aircraft to the list of aircraft, and/or remove aircraft from the list of aircraft. The operators screen 606 may include identifiers of operators associated with the owner. Each of the identifiers of the operators may be selectable, and when selected may cause additional details associated with the operators to be presented on the user interface 600. The owner may be enabled to add, remove, or change details associated with the operators.

The notifications screen 608 may include notifications associated with the given owner. For example, the notifications shown in FIG. 6 are Notification E and Notification F. It should be understood that one, two, or more than two notifications may be displayed in the notifications screen 608. The substance of the notifications and/or details associated with the notifications may also be displayed in the notifications screen 608. By way of example, the notification details may include a time at which the notification was received, a date at which the notification was received, and/or an identifier of the sender of the notification and/or an identifier of an entity about which the notification pertains. It should be understood that any information associated with a given notification may be displayed in the notifications screen 608. Also, all or a portion of the notifications as displayed in the notifications screen 608 may be selectable, and when selected may cause the substance of the notification to be displayed via the user interface 600.

The user interface 600 may also include one or more selectable elements, such as an edit profile element 610, an edit operators element 612, a manage payments element 614, a messaging element 616, and/or an affiliate management element 620. The edit profile element 610 may allow an owner to edit information associated with that owner. The edit operators element 612 may allow an owner to add, remove, or change information related to one or more aerial vehicle operators. The management payments element 614 may allow the owner to visualize payments for flights associated with the owner as well as statuses of those payments, and may allow the owner to change account information associated with payments. The messaging element 616 may allow the owner to compose and send one or more messages to travelers, brokers, operators, and/or other entities associated with aerial vehicle flights. Details on the sending of messages utilizing the aviation-based user platform are described in more detail elsewhere herein.

The affiliate management element 620 may allow an owner and/or other user to view information and to make selections for affiliate management, such as with respect to other owners, brokers, operators, flight staffing, etc. In this way, the platform may provide owners with the ability to select how to manage affiliate relationships. This may also provide a user interface 600 for the owner to visualize how affiliate relationships are being managed. Affiliate management, as described herein, may allow for actions to be taken more quickly and/or accurately by the platform, which may result in a more positive user experience for the entities involved in the platform, and particularly for travelers using the platform. This portion of the user interface 600 may also be configured to receive user input for the provision of additional travel-related services to be offered on the platform, including, for example, limousine and/or car rental services, accommodations, etc.

The user interface 600 may also include a cooperative flight search portion 618. This functionality may allow an owner to search for aerial vehicles owned by other owners that have been designated as participating in a cooperative program amongst owners. In such a program, the participants have agreed to allow other owners to utilize their aerial vehicles in exchange for use of other owners' aerial vehicles. For example, one owner may have booked at flight using an aerial vehicle during a certain time, but that owner may thereafter want to utilize an aerial vehicle in place of the owner's aerial vehicle. The owner may utilize the cooperative flight search portion 618 to input search terms for an aerial vehicle and search results associated with owners that participate in the cooperative program may be displayed and selected to book a flight. The user interface 600 may also allow for the owner to view, in real time in examples, where associated aerial vehicles are located, details about flights for the aerial vehicles, availabilities of cooperative program aerial vehicles, and/or other information that shows market placement of owner assets associated with the platform.

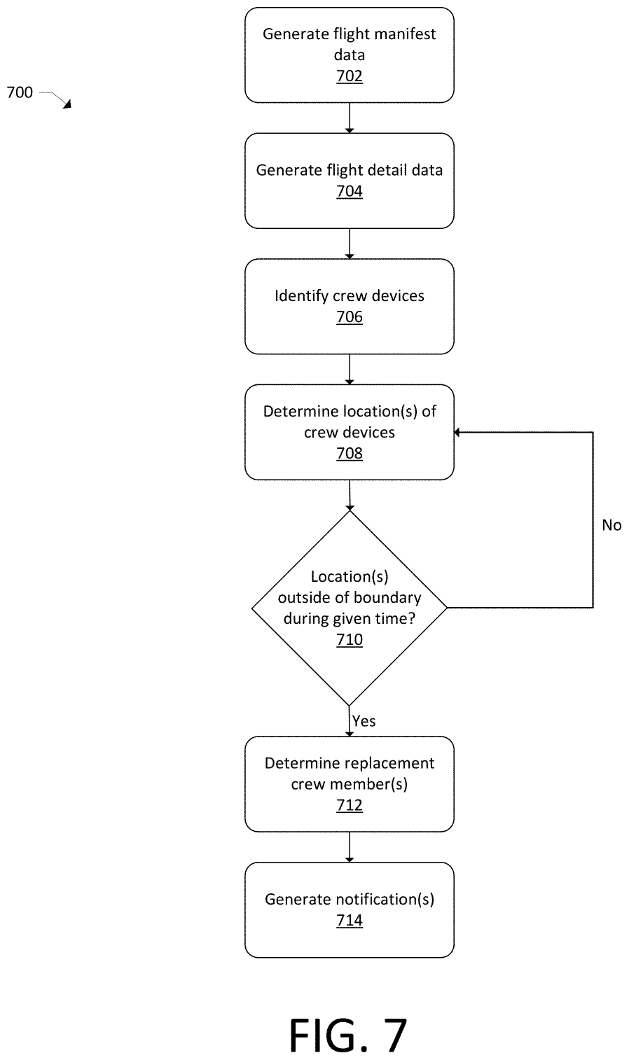

FIGS. 7-20 illustrate processes for aviation-based user platforms. The processes described herein are illustrated as collections of blocks in logical flow diagrams, which represent a sequence of operations, some or all of which may be implemented in hardware, software or a combination thereof. In the context of software, the blocks may represent computer-executable instructions stored on one or more computer-readable media that, when executed by one or more processors, program the processors to perform the recited operations. Generally, computer-executable instructions include routines, programs, objects, components, data structures and the like that perform particular functions or implement particular data types. The order in which the blocks are described should not be construed as a limitation, unless specifically noted. Any number of the described blocks may be combined in any order and/or in parallel to implement the process, or alternative processes, and not all of the blocks need be executed. For discussion purposes, the processes are described with reference to the environments, architectures and systems described in the examples herein, such as, for example those described with respect to FIGS. 1-6, although the processes may be implemented in a wide variety of other environments, architectures and systems.

FIG. 7 illustrates a flow diagram of an example process 700 for tracking staff members associated with a scheduled flight via an aviation-based user platform. The order in which the operations or steps are described is not intended to be construed as a limitation, and any number of the described operations may be combined in any order and/or in parallel to implement process 700.

At block 702, the process 700 may include generating flight manifest data. For example, a manifest component of a remote system may be configured to generate flight manifest data for a given flight. For example, during the booking process, the booking traveler and/or a proxy may be asked to provide information for all travelers for the flight. The booking traveler and/or proxy may provide identifying information for the booking traveler as well as an identifier for other travelers and contact information for those travelers. The manifest component may utilize the contact information for the other travelers to send a request for information to those travelers. The request may include instructions for accessing the aviation-based platform for providing identifying information for the travelers and/or may enable the travelers to provide information for generating a user profile for the travelers. Once this data is received from the other travelers, the manifest component may be utilized to generate a flight manifest for the flight. The flight manifest may identify the travelers and at least a portion of identifying information about the travelers. The manifest may also include user preferences associated with the travelers, traveler restrictions and/or requests, and/or other data that may be required or desired for allowing the travelers to travel on the flight. The flight manifest data may be stored in one or more database of the aviation-based user platform and may be accessible to those entities that may require the flight manifest data, such as the operator, pilot, etc.

At block 704, the process 700 may include generating flight data. For example, the flight data may include details about a scheduled flight, such as traveler identifiers, traveler information, user preference data, duration of flight, departure time and location, details about the aerial vehicle, details about the crew associated with the aerial vehicle, details about the operator and/or owner, and/or any other information associated with a flight.

At block 706, the process 700 may include identifying crew devices. For example, the flight data may be utilized to identifier crew profile associated with crew scheduled to be associated with the flight. The crew profiles may include device identifiers for devices associated with the crew.

At block 708, the process 700 may include determining one or more locations of the crew devices. For example, a geolocation component of the crew devices may be queried for an approximate location of the devices at a given time.

At block 710, the process 700 may include determining whether the one or more locations are outside of a boundary of a departure location associated with the flight during a given time. For example, depending on an amount of time from when the crew are scheduled to be at the aerial vehicle or otherwise when the crew are supposed to arrive at the departure location, a boundary may be dynamically set. By way of example, if crew are supposed to be at the departure location in 30 minutes for the flight to depart on time, a boundary around the departure location may be determined where devices located within the boundary are likely to arrive on time and devices outside the boundary are likely to not arrive on time. The boundary determination may take into consideration contextual information, such as weather, traffic, event indications, and/or any other type of data that may hinder arrival of the device at the departure location.

In instances where the locations are not outside of the boundary, the process 700 may return to block 708 and the operation of determining the one or more locations of the crew devices and determining whether those locations are outside of the boundary may be performed again.

In instances where at least one of the locations are outside of the boundary, the process 700 may include, at block 712, determining one or more replacement crew members. For example, replacement crew members having the same crew type (e.g., staff, pilot, etc.) may be determined and their devices may be queried for a geolocation indicator. If a given crew member's device is within the boundary, that crew member may be determined to be a replacement crew member.

At block 714, the process 700 may include generating one or more notifications associated with the replacement crew member(s). For example, once the replacement crew member has accepted a request to replace the other crew member, one or more notifications may be generated and sent to entities associated with the flight, such as the traveler(s), the broker, the operator, and/or the owner, as well as the initial crew member and/or the replacement crew member.

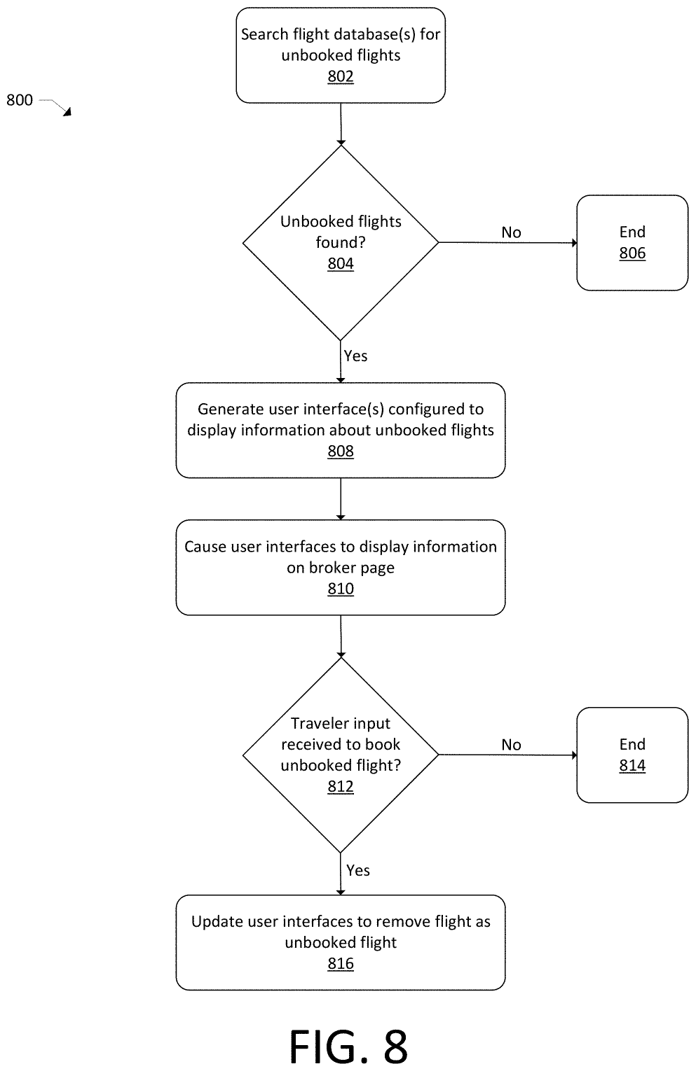

FIG. 8 illustrates a flow diagram of an example process 800 for identifying and presenting unscheduled but available flights via an aviation-based user platform. The order in which the operations or steps are described is not intended to be construed as a limitation, and any number of the described operations may be combined in any order and/or in parallel to implement process 800.

At block 802, the process 800 may include searching one or more flight databases for unbooked flights. For example, the aviation-based user platform may be configured to preemptively identify “empty leg” flights. These empty leg flights may correspond to unbooked flights that operators and/or owners wish to book but that might not necessarily be presented as results to a search query by a traveler. Booking empty leg flights may be advantageous to travelers because those flights may be offered at a discounted rate. To do so, a flight identifier of the remote system may identify one or more flights that are frequently unscheduled and/or situations where an aerial vehicle was utilized for a one-way flight and the operator and/or owner desires to have the aerial vehicle travel back to the original departure location.

At block 804, the process 800 may include determining whether one or more unbooked flights are found. For example, the flight identifier may identify the flight and generate availability data indicating details of the unscheduled flight.

In instances where at least one unbooked flight is not found, the process 800 may end at block 806. In this example, no empty legs may be found.

In instances where at least one unbooked flight is found, the process 800 may include, at block 808, generating one or more user interfaces configured to display information about the unbooked flight(s). The user interfaces may be configured to indicate that the flight is an empty leg flight and provide information associated with pricing of that flight.

At block 810, the process 800 may include causing the user interface(s) to display the information on a broker page. In examples, identifiers of the unscheduled flights may be displayed based at least in part on a traveler request to display such information, based at least in part on a potential departure location of a traveler, based at least in part on a geolocation of a traveler device, based at least in part on historical flight data, and/or based at least in part on user preferences of travelers and/or brokers.

At block 812, the process 800 may include determining whether traveler input has been received to book the unbooked flight. The traveler input may include the selection of the flight from the user interface and/or any other input indicating a desire to book the flight.

In instances where traveler input is not received, the process 800 may end at block 814. In these examples, the empty leg flight may be displayed but the traveler may not desire to book the flight.

In instances where the traveler input is received, the process 800 may include, at block 816, updating the user interfaces to remove the flight as an unbooked flight. For example, the empty leg flight may be booked for use by the traveler, and then the system may be updated to reflect that the flight is no longer available as an empty leg flight. By so doing, the availability of empty leg flights may be updated on the fly to accurately reflect current empty leg flight inventory.

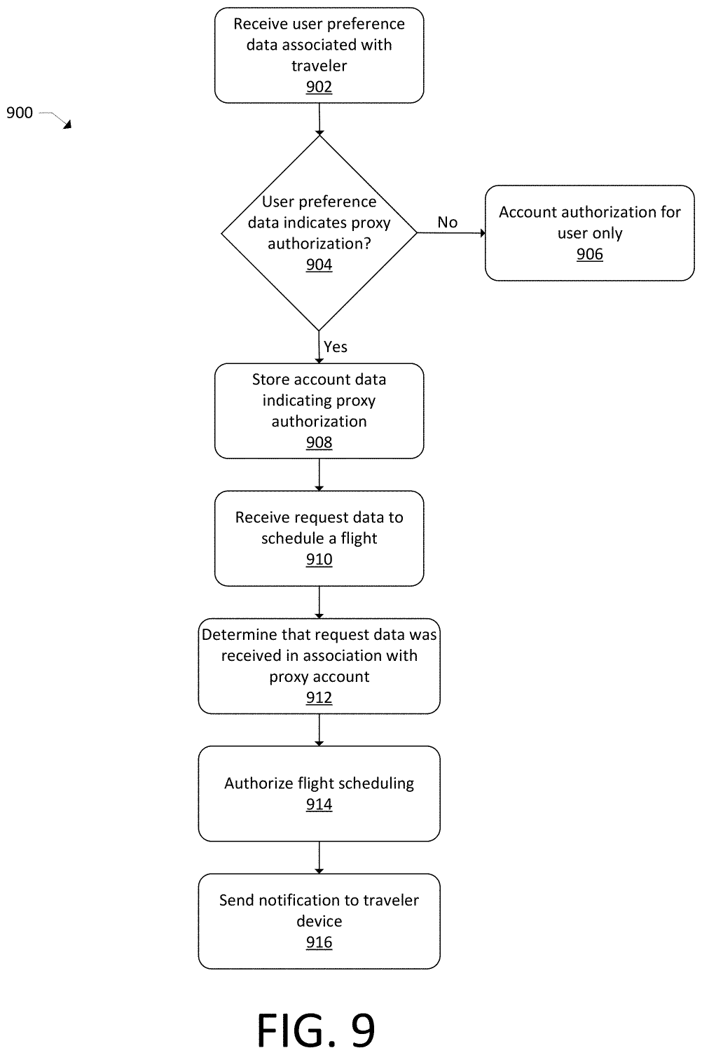

FIG. 9 illustrates a flow diagram of an example process 900 for authorizing and utilizing proxies for scheduling flights via an aviation-based user platform. The order in which the operations or steps are described is not intended to be construed as a limitation, and any number of the described operations may be combined in any order and/or in parallel to implement process 900.

At block 902, the process 900 may include receiving user preference data associated with a traveler. The user preference data may include one or more preferences associated with a given user, such as crew preferences, aerial vehicle preferences, messaging preferences, payment preferences, dietary preferences, allergy information, disability information, and/or other information associated with a user, including proxy authorization information.

At block 904, the process 900 may include determining whether the user preference data indicates proxy authorization. For example, a proxy component of the remote system may be configured to authorize the use of proxies for flight scheduling. For example, a given traveler may desire to authorize one or more other people to schedule flights for the traveler such that the traveler does not need to schedule flights for her/himself. To do so, the proxy component may be configured to display one or more proxy authorization options for the traveler. The proxy authorization options may include an identifier of a user profile and/or person identifier to which the traveler would like to associate with as a proxy as well as a degree of authorization allowed by the traveler. The degree of authorization may include full authorization to search for, schedule, and change flights, and/or the degree of authorization may include one or more limits on the ability of the proxy to search for, schedule, and change flights. The proxy authorization options may also include notification preferences when the proxy authorizes a flight on behalf of the traveler. Once the proxy authorization options are set, the proxy may utilize the proxy's user profile to search for, schedule, and change flights on behalf of the traveler.

In instances where the user preference data does not indicate proxy authorization, the process 900 may include, at block 906, allowing for account authorization by only the traveler. In these examples, only the user profile associated with the traveler may be authorized to book flights, and any attempt to book a flight for the traveler by another user profile may be rejected.

In instances where the user preference data indicates proxy authorization, the process 900 may include, at block 908, storing account data indicating the proxy authorization. For example, one or more databases of the aviation-based user profile may store data indicating the proxy authorization.

At block 910, the process 900 may include receiving request data to schedule a flight. For example, a user may utilize the aviation-based user platform to receive request data for flight scheduling, such as through the broker web pages described herein.

At block 912, the process 900 may include determining that the request data was received in association with a proxy account. For example, the user account that is associated with the user input to book the flight may have an account identifier, and that account identifier may be compared to account identifiers of proxy accounts.

At block 914, the process 900 may include authorizing flight scheduling based at least in part on the proxy account being authorized to schedule flights on behalf of the traveler. In this example, the user account from which the flight booking request data was received may correspond to one of the authorized proxy accounts for a given traveler. As such, booking of the flight may be scheduled utilizing the scheduling component as described more fully herein.

At block 916, the process 900 may include sending a notification to a traveler device associated with the traveler. For example, a notification component of the remote system may generate and send a notification to the traveler indicating that a proxy has authorized a flight, and the notification may provide details associated with the flight. This may allow the traveler to confirm the scheduled flight and/or alter the scheduled flight and/or cancel the scheduled flight.

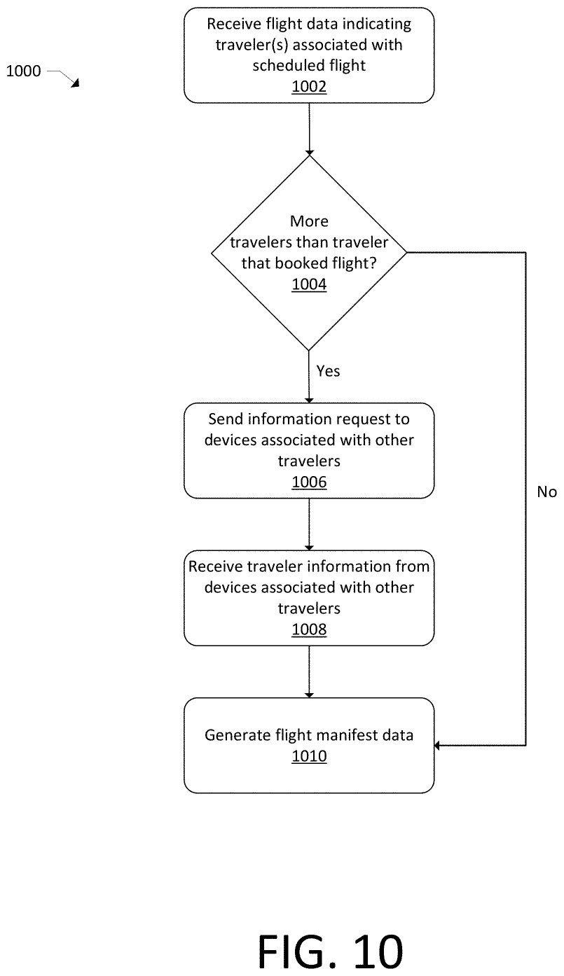

FIG. 10 illustrates a flow diagram of an example process 1000 for generation of flight manifest data associated with an aviation-based user platform. The order in which the operations or steps are described is not intended to be construed as a limitation, and any number of the described operations may be combined in any order and/or in parallel to implement process 1000.

At block 1002, the process 1000 may include receive flight data indicating one or more traveler(s) associated with a scheduled flight. The flight data may include identifying information associated with the traveler that booked the flight as well as identifiers of other travelers and/or contact information associated with those other travelers that are to be associated with the flight.

At block 1004, the process 1000 may include determining whether more travelers than just the traveler that booked the flight are indicated by the flight data. For example, the flight data may be queried to determine if identifiers of any other travelers are received.

In instances where more travelers than just the traveler that booked the flight are indicated, the process 1000 may include, at block 1006, sending an information request to devices associated with the other travelers. For example, the contact information associated with the other travelers may be utilized to send the information request to devices associated with those travelers.

At block 1008, the process 1000 may include receiving the traveler information from the devices associated with the other travelers. For example, the other travelers may provide user input to their devices that is responsive to the information request, and corresponding user input data may be generated and sent to the remote system.

At block 1010, the process 1000 may include generating flight manifest data utilizing the traveler information. Also, returning to block 1004, when there are not more travelers than the traveler that booked the flight, the process 1000 may continue to block 1010 where the flight manifest data may be generated utilizing the flight data received at block 1002. For example, the flight manifest data may be generated utilizing the traveler information provided by the booking traveler as well as the user input data provided by the other travelers.

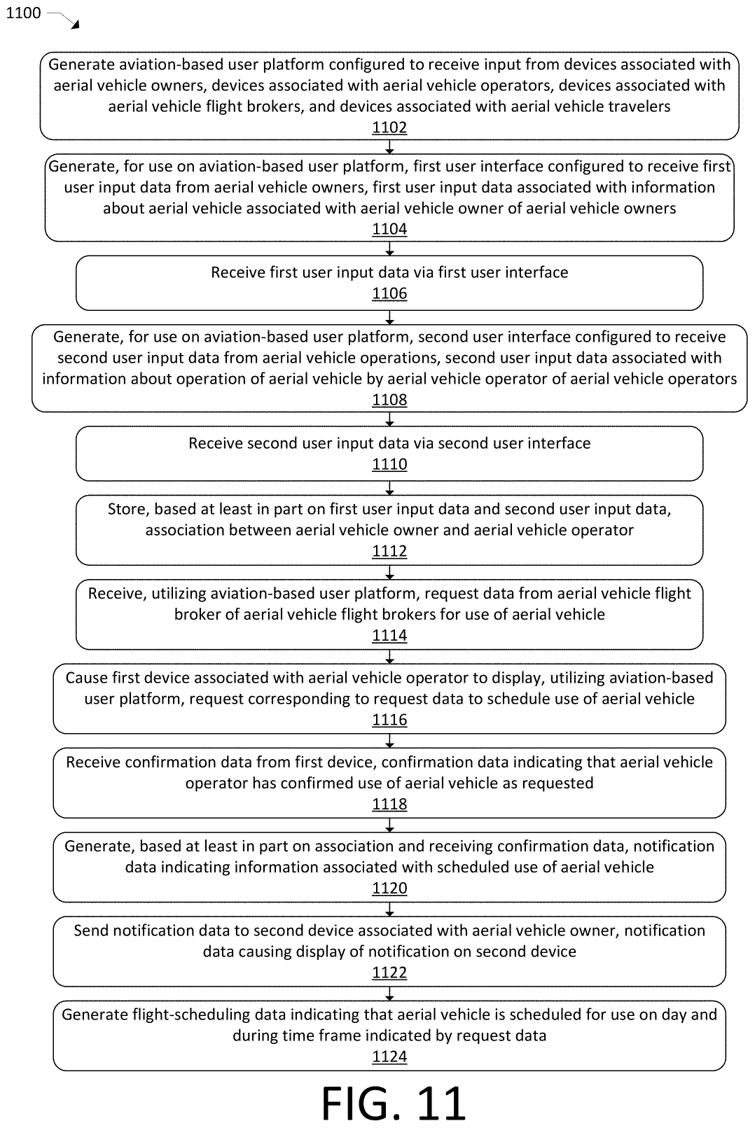

FIG. 11 illustrates a flow diagram of an example process 1100 for utilizing aerial vehicle operator functionality associated with an aviation-based user platform. The order in which the operations or steps are described is not intended to be construed as a limitation, and any number of the described operations may be combined in any order and/or in parallel to implement process 1100.

At block 1102, the process 1100 may include generating an aviation-based user platform configured to receive input from devices associated with aerial vehicle owners, devices associated with aerial vehicle operators, devices associated with aerial vehicle flight brokers, and devices associated with aerial vehicle travelers. For example, the environment for which the aviation-based user platform may be utilized may include one or more traveler devices, one or more broker devices, one or more operator devices, and one or more owner devices. These devices may be any computing devices configured to receive user input and to display information. The environment may also include a remote system, which is remote from one or more of the traveler devices, the broker devices, the operator devices, and the owner devices. The remote system may include one or more components that may allow for use of the aviation-based user platform. For example, the remote system may include one or more user interfaces that may be configured for display on one or more of the traveler devices, the broker devices, the operator device, and/or the owner devices.

At block 1104, the process 1100 may include generating, for use on the aviation-based user platform, a first user interface configured to receive first user input data from the aerial vehicle owners, the first user input data associated with information about an aerial vehicle associated with an aerial vehicle owner of the aerial vehicle owners. For example, the user interface may be the same or similar to the user interface 600 described with respect to FIG. 6.

At block 1106, the process 1100 may include receiving the first user input data via the first user interface.

At block 1108, the process 1100 may include generating, for use on the aviation-based user platform, a second user interface configured to receive second user input data from the aerial vehicle operations, the second user input data associated with information about operation of the aerial vehicle by an aerial vehicle operator of the aerial vehicle operators. For example, the user interface may be the same or similar to the user interface 500 described with respect to FIG. 5.

At block 1110, the process 1100 may include receiving the second user input data via the second user interface.

At block 1112, the process 1100 may include storing, based at least in part on the first user input data and the second user input data, an association between the aerial vehicle owner and the aerial vehicle operator. For example, user profiles associated with the operator and owner may be stored in association with the aviation-based user platform, and data indicating a relationship between the owner user profile and the operator user profile may be stored.

At block 1114, the process 1100 may include receiving, utilizing the aviation-based user platform, request data from an aerial vehicle flight broker of the aerial vehicle flight brokers for the use of the aerial vehicle. For example, a traveler may utilize a web page associated with the broker to indicate a flight to be scheduled, and the web page may be utilized to transmit that information to the aviation-based user platform.

At block 1116, the process 1100 may include causing a first device associated with the aerial vehicle operator to display, utilizing the aviation-based user platform, a request corresponding to the request data to schedule use of the aerial vehicle. For example, the request may indicate that flight to be booked, traveler information, broker information, and/or any other information associated with the flight as well as functionality for accepting or rejecting the request.

At block 1118, the process 1100 may include receiving confirmation data from the first device, the confirmation data indicating that the aerial vehicle operator has confirmed use of the aerial vehicle as requested. For example, the operator may have accepted the request and user input data indicating as much may be sent from the operator device to the aviation-based user platform.

At block 1120, the process 1100 may include generating, based at least in part on the association and receiving the confirmation data, notification data indicating information associated with scheduled use of the aerial vehicle. For example, a notification component of the aviation-based user platform may generate the notification, which may include the information associated with the scheduled use of the aerial vehicle, along with details associated with the flight.

At block 1122, the process 1100 may include sending the notification data to a second device associated with the aerial vehicle owner, the notification data causing display of a notification on the second device. This may allow the owner to view details of the scheduled flight and make changes in certain examples.

At block 1124, the process 1100 may include generating flight-scheduling data indicating that the aerial vehicle is scheduled for use on a day and during a time frame indicated by the request data. For example, a scheduling component of the aviation-based user platform may generate the flight-scheduling data, which may be associated with the entities associated with the flight, such as travelers, the broker, the operator, the owner, crew, etc.

Additionally, or alternatively, the process 1100 may include receiving second request data from the aerial vehicle flight broker for use of the aerial vehicle on a second day and during a second time frame. The process 1100 may also include determining that at least one of the aerial vehicle owner or the aerial vehicle operator has provided input data indicating that requests for use of the aerial vehicle on the second day and during the second time frame are pre-approved such that additional input from the aerial vehicle owner and the aerial vehicle operator is unnecessary. The process 1100 may also include generating, based at least in part on the input data and without requesting confirmation from the aerial vehicle owner and the aerial vehicle operator, second flight-scheduling data indicating that the aerial vehicle is scheduled for use on the second day and during the second time frame.

Additionally, or alternatively, the process 1100 may include generating a pricing model configured to determine a price for use of the aerial vehicle. The process 1100 may also include storing pricing data indicating historical prices for use of at least one of the aerial vehicle or additional aerial vehicles of a vehicle type associated with the aerial vehicle. The process 1100 may also include training the pricing model utilizing the pricing data such that a trained pricing model is generated. The process 1100 may also include determining, utilizing the trained pricing model and with at least a portion of the request data as input, the price for use of the aerial vehicle on the day and during the time frame. The process 1100 may also include associating the price with the flight-scheduling data.

Additionally, or alternatively, the process 1100 may include generating, for use on the aviation-based user platform, a third user interface configured to display, on the second device associated with the aerial vehicle owner, current availability of other aerial vehicles associated with other aerial vehicle owners. The process 1100 may also include filtering, based at least in part on geolocation data associated with the aerial vehicle owner, the other aerial vehicles to a subset of the other aerial vehicles. The process 1100 may also include receiving third user input data indicating selection of one of the subset of the other aerial vehicles for use by the aerial vehicle owner. The process 1100 may also include generating second flight-scheduling data indicating scheduled use of the one of the subset of the other aerial vehicles by the aerial vehicle owner.

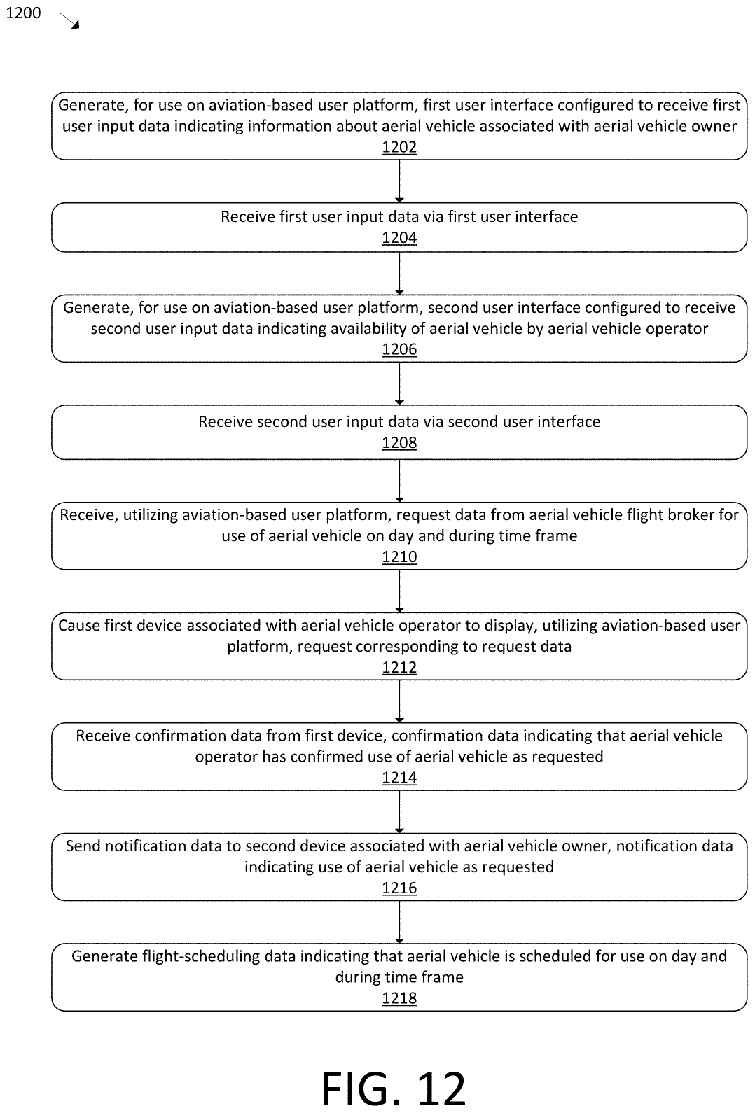

FIG. 12 illustrates a flow diagram of another example process 1200 for utilizing aerial vehicle operator functionality associated with an aviation-based user platform. The order in which the operations or steps are described is not intended to be construed as a limitation, and any number of the described operations may be combined in any order and/or in parallel to implement process 1200.

At block 1202, the process 1200 may include generating, for use on an aviation-based user platform, a first user interface configured to receive first user input data indicating information about an aerial vehicle associated with an aerial vehicle owner. For example, the user interface may be the same or similar to the user interface 600 described with respect to FIG. 6.

At block 1204, the process 1200 may include receiving the first user input data via the first user interface.

At block 1206, the process 1200 may include generating, for use on the aviation-based user platform, a second user interface configured to receive second user input data indicating availability of the aerial vehicle by an aerial vehicle operator. For example, the user interface may be the same or similar to the user interface 500 described with respect to FIG. 5.

At block 1208, the process 1200 may include receiving the second user input data via the second user interface.

At block 1210, the process 1200 may include receiving, utilizing the aviation-based user platform, request data from an aerial vehicle flight broker for use of the aerial vehicle on a day and during a time frame. For example, a traveler may utilize a web page associated with the broker to indicate a flight to be scheduled, and the web page may be utilized to transmit that information to the aviation-based user platform.

At block 1212, the process 1200 may include causing a first device associated with the aerial vehicle operator to display, utilizing the aviation-based user platform, a request corresponding to the request data. For example, the request may indicate that flight to be booked, traveler information, broker information, and/or any other information associated with the flight as well as functionality for accepting or rejecting the request.

At block 1214, the process 1200 may include receiving confirmation data from the first device, the confirmation data indicating that the aerial vehicle operator has confirmed the use of the aerial vehicle as requested. For example, the operator may have accepted the request and user input data indicating as much may be sent from the operator device to the aviation-based user platform.

At block 1216, the process 1200 may include sending notification data to a second device associated with the aerial vehicle owner, the notification data indicating the use of the aerial vehicle as requested. For example, a notification component of the aviation-based user platform may generate the notification, which may include the information associated with the scheduled use of the aerial vehicle, along with details associated with the flight.

At block 1218, the process 1200 may include generating flight-scheduling data indicating that the aerial vehicle is scheduled for the use on the day and during the time frame. For example, a scheduling component of the aviation-based user platform may generate the flight-scheduling data, which may be associated with the entities associated with the flight, such as travelers, the broker, the operator, the owner, crew, etc.

Additionally, or alternatively, the process 1200 may include receiving second request data from the aerial vehicle flight broker for use of the aerial vehicle on a second day and during a second time frame. The process 1200 may also include determining that user account data associated with the aerial vehicle indicates that approval of requests for use of the aerial vehicle on the second day and during the second time frame is unnecessary. The process 1200 may also include generating, based at least in part on the user account data, second flight-scheduling data indicating that the aerial vehicle is scheduled for use on the second day and during the second time frame.

Additionally, or alternatively, the process 1200 may include generating a pricing model configured to determine a price for use of the aerial vehicle. The process 1200 may also include storing pricing data indicating historical prices for use of at least one of the aerial vehicle or additional aerial vehicles. The process 1200 may also include training the pricing model utilizing the pricing data such that a trained pricing model is generated and determining, utilizing the trained pricing model, a suggested price for use of the aerial vehicle. The process 1200 may also include associating the suggested price with the flight-scheduling data.

Additionally, or alternatively, the process 1200 may include generating a third user interface configured to display, on devices associated with aerial vehicle owners, current availability of other aerial vehicles associated with other aerial vehicle owners. The process 1200 may also include receiving third user input data indicating selection of one of the other aerial vehicles for use by the aerial vehicle owner. The process 1200 may also include generating second flight-scheduling data indicating scheduled use of the one of the other aerial vehicles by the aerial vehicle owner.

Additionally, or alternatively, the process 1200 may include associating a first anonymized identifier with a traveler associated with the request data, wherein the confirmation data includes the first anonymized identifier instead of a name of the traveler. The process 1200 may also include associating a second anonymized identifier with the aerial vehicle owner, wherein the flight-schedule data includes the second anonymized identifier instead of a name of the aerial vehicle owner.

Additionally, or alternatively, the process 1200 may include determining a given day of the week and a given time at which the aerial vehicle is available for use. The process 1200 may also include determining a vehicle type associated with the aerial vehicle and determining one or more characteristics of the aerial vehicle. The process 1200 may also include querying a database for other aerial vehicles having the vehicle type and at least one of the one or more characteristics. The process 1200 may also include generating, as a training dataset, pricing data associated with use of the other aerial vehicles on the given day of the week and at the given time. The process 1200 may also include training a pricing model based at least in part on the pricing data.

Additionally, or alternatively, the process 1200 may include determining, utilizing the request data, a departure location associated with the request. The process 1200 may also include querying, in response to receiving the request data, geolocation data associated with aerial vehicles associated with the aviation-based user platform. The process 1200 may also include determining, based at least in part on the geolocation data, that the aerial vehicle is available for departure at the departure location. In these examples, causing the first device to display the request may be based at least in part on the aerial vehicle being available for departure at the departure location.

Additionally, or alternatively, the process 1200 may include determining, at a time within a threshold amount of time from the day and the time frame, a geolocation of one or more staff indicated as associated with departure of the aerial vehicle. The process 1200 may include determining that the geolocation exceeds a threshold distance from a departure location of the aerial vehicle. The process 1200 may include in response to the geolocation exceeding the threshold distance, identifying an alternative staff person associated with the aviation-based user platform with a current geolocation within the threshold distance. The process 1200 may also include sending a query to a device associated with the alternative staff person to perform scheduled tasks of the one or more staff.

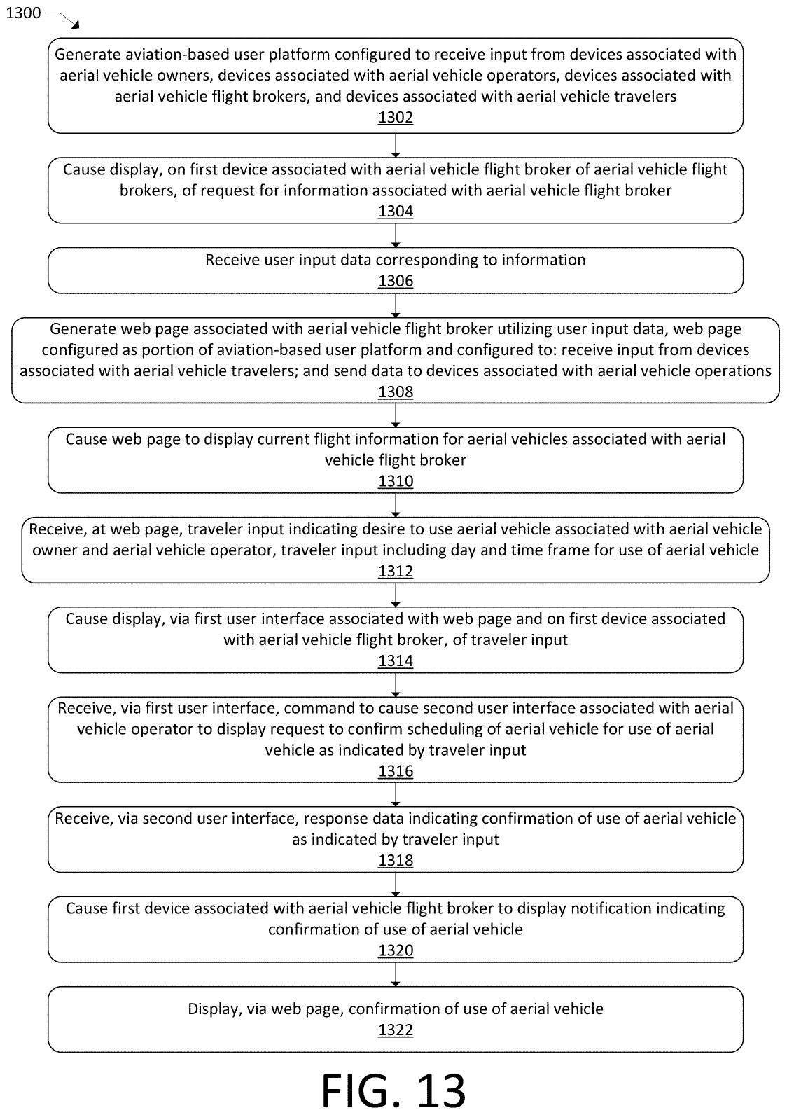

FIG. 13 illustrates a flow diagram of an example process 1300 for utilizing aerial vehicle traveler and aerial vehicle flight broker functionality associated with an aviation-based user platform. The order in which the operations or steps are described is not intended to be construed as a limitation, and any number of the described operations may be combined in any order and/or in parallel to implement process 1300.

At block 1302, the process 1300 may include generating an aviation-based user platform configured to receive input from devices associated with aerial vehicle owners, devices associated with aerial vehicle operators, devices associated with aerial vehicle flight brokers, and devices associated with aerial vehicle travelers. For example, the environment for which the aviation-based user platform may be utilized may include one or more traveler devices, one or more broker devices, one or more operator devices, and one or more owner devices. These devices may be any computing devices configured to receive user input and to display information. The environment may also include a remote system, which is remote from one or more of the traveler devices, the broker devices, the operator devices, and the owner devices. The remote system may include one or more components that may allow for use of the aviation-based user platform. For example, the remote system may include one or more user interfaces that may be configured for display on one or more of the traveler devices, the broker devices, the operator device, and/or the owner devices.

At block 1304, the process 1300 may include causing display, on a first device associated with an aerial vehicle flight broker of the aerial vehicle flight brokers, of a request for information associated with the aerial vehicle flight broker. For example, the request for information may query the broker for information associated with the broker, the operators associated with the broker, the owners associated with the broker, aerial vehicles associated with the broker, and/or other information associated with flights to be offered by the broker for booking by travelers.

At block 1306, the process 1300 may include receiving user input data corresponding to the information.

At block 1308, the process 1300 may include generating a web page associated with the aerial vehicle flight broker utilizing the user input data, the web page configured as a portion of the aviation-based user platform and configured to: receive input from the devices associated with aerial vehicle travelers; and send data to the devices associated with the aerial vehicle operations. For example, the web page may be the same or similar to the web page 302 described with respect to FIG. 3.

At block 1310, the process 1300 may include causing the web page to display current flight information for aerial vehicles associated with the aerial vehicle flight broker. For example, the current flight information may be displayed in response to a search query by a traveler and/or the current flight information may be proactively displayed for any traveler accessing the web page.

At block 1312, the process 1300 may include receiving, at the web page, traveler input indicating a desire to use an aerial vehicle associated with an aerial vehicle owner and an aerial vehicle operator, the traveler input including a day and a time frame for use of the aerial vehicle. For example, the user interface 300 described with respect to FIG. 3 may be utilized to receive the traveler input.

At block 1314, the process 1300 may include causing display, via a first user interface associated with the web page and on the first device associated with the aerial vehicle flight broker, of the traveler input. For example, the user interface 400 described with respect to FIG. 4 may be utilized to display the traveler input.

At block 1316, the process 1300 may include receiving, via the first user interface, a command to cause a second user interface associated with the aerial vehicle operator to display a request to confirm scheduling of the aerial vehicle for the use of the aerial vehicle as indicated by the traveler input. For example, the aerial vehicle operator may be presented with the second user interface that provides details of the scheduled use of the aerial vehicle along with functionality for accepting or rejecting the use.

At block 1318, the process 1300 may include receiving, via the second user interface, response data indicating confirmation of the use of the aerial vehicle as indicated by the traveler input.

At block 1320, the process 1300 may include causing the first device associated with the aerial vehicle flight broker to display a notification indicating the confirmation of the use of the aerial vehicle. For example, a notification component may be configured to generate and send the notification to the device associated with the broker, and that notification may be displayed for the broker.

At block 1322, the process 1300 may include displaying, via the web page, the confirmation of the use of the aerial vehicle. This may serve as confirmation of flight scheduling as well as details associated with the flight.

Additionally, or alternatively, the process 1300 may include receiving an indication that one or more characteristics associated with the use of the aerial vehicle has changed since displaying the confirmation, the one or more characteristics including at least an identifier of a pilot, an identifier of the aerial vehicle, and an identifier of a staff member associated with the aerial vehicle. The process 1300 may also include causing the web page to display a second notification that the one or more characteristics has changed.

Additionally, or alternatively, the process 1300 may include receiving, via the web page, an information update from the aerial vehicle traveler. The process 1300 may also include causing a second notification of the information update to be sent to a second device associated with the aerial vehicle operator. The process 1300 may also include receiving, via the web page, a response from the aerial vehicle operator. The process 1300 may also include causing a third notification of the response to be sent to the a third device associated with the aerial vehicle traveler.

Additionally, or alternatively, the process 1300 may include determining, utilizing flight scheduling data associated with the aviation-based user platform, one or more unscheduled flights associated with the aerial vehicles associated with the aerial vehicle flight broker. The process 1300 may also include generating flight data indicating the one or more unscheduled flights and times associated with when the unscheduled flights are available. The process 1300 may also include causing the web page to display, utilizing the flight data, the one or more unscheduled flights and the times.

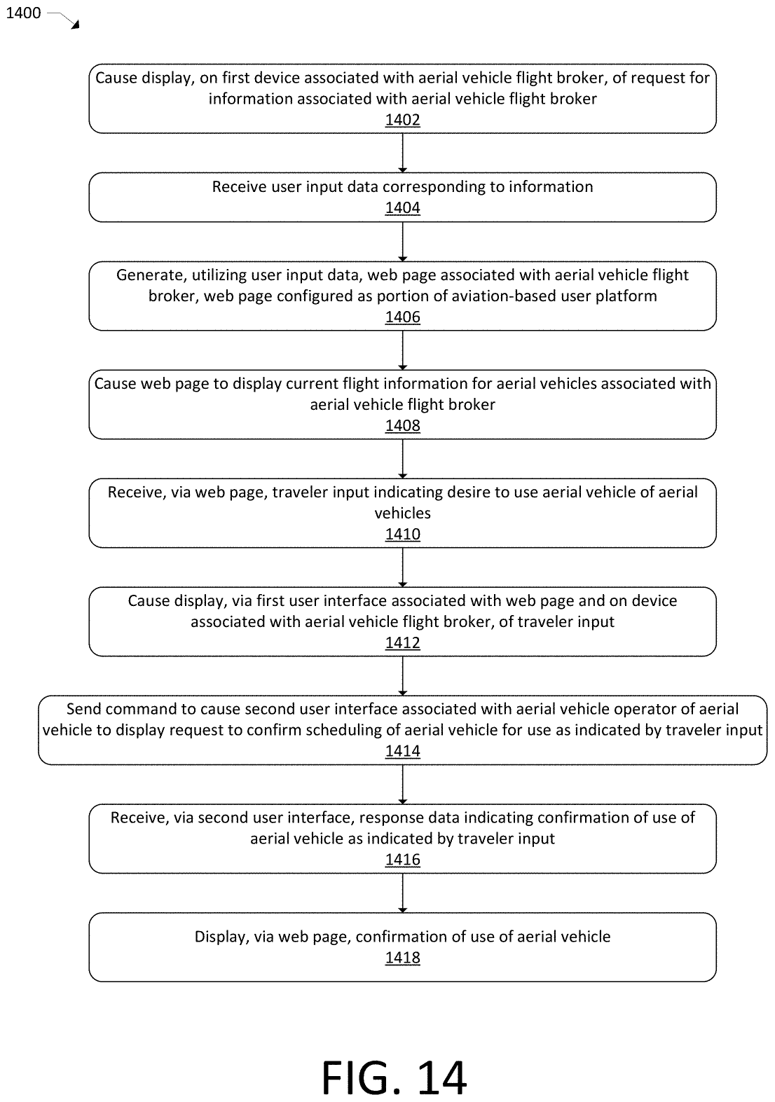

FIG. 14 illustrates a flow diagram of another example process 1400 for utilizing aerial vehicle traveler and aerial vehicle flight broker functionality associated with an aviation-based user platform. The order in which the operations or steps are described is not intended to be construed as a limitation, and any number of the described operations may be combined in any order and/or in parallel to implement process 1400.

At block 1402, the process 1400 may include causing display, on a first device associated with an aerial vehicle flight broker, of a request for information associated with the aerial vehicle flight broker. For example, the request for information may query the broker for information associated with the broker, the operators associated with the broker, the owners associated with the broker, aerial vehicles associated with the broker, and/or other information associated with flights to be offered by the broker for booking by travelers.

At block 1404, the process 1400 may include receiving user input data corresponding to the information.

At block 1406, the process 1400 may include generating, utilizing the user input data, a web page associated with the aerial vehicle flight broker, the web page configured as a portion of an aviation-based user platform. For example, the web page may be the same or similar to the web page 302 described with respect to FIG. 3.

At block 1408, the process 1400 may include causing the web page to display current flight information for aerial vehicles associated with the aerial vehicle flight broker. For example, the current flight information may be displayed in response to a search query by a traveler and/or the current flight information may be proactively displayed for any traveler accessing the web page.

At block 1410, the process 1400 may include receiving, via the web page, traveler input indicating a desire to use an aerial vehicle of the aerial vehicles. For example, the user interface 300 described with respect to FIG. 3 may be utilized to receive the traveler input.

At block 1412, the process 1400 may include causing display, via a first user interface associated with the web page and on the device associated with the aerial vehicle flight broker, of the traveler input. For example, the user interface 400 described with respect to FIG. 4 may be utilized to display the traveler input.

At block 1414, the process 1400 may include sending a command to cause a second user interface associated with an aerial vehicle operator of the aerial vehicle to display a request to confirm scheduling of the aerial vehicle for the use as indicated by the traveler input. For example, the aerial vehicle operator may be presented with the second user interface that provides details of the scheduled use of the aerial vehicle along with functionality for accepting or rejecting the use.

At block 1416, the process 1400 may include receiving, via the second user interface, response data indicating confirmation of the use of the aerial vehicle as indicated by the traveler input.

At block 1418, the process 1400 may include displaying, via the web page, the confirmation of the use of the aerial vehicle. This may serve as confirmation of flight scheduling as well as details associated with the flight.

Additionally, or alternatively, the process 1400 may include receiving an indication that a characteristic associated with the use of the aerial vehicle has changed since displaying the confirmation. The process 1400 may also include causing the web page to display a notification that the a characteristic has changed such that the notification is viewable to the aerial vehicle traveler.

Additionally, or alternatively, the process 1400 may include receiving, via the web page, an information update from the aerial vehicle traveler. The process 1400 may also include causing a first notification of the information update to be sent to a second device associated with the aerial vehicle operator. The process 1400 may also include receiving, via the web page, a response from the first device. The process 1400 may also include causing a second notification of the response to be sent to a third device associated with the aerial vehicle traveler.

Additionally, or alternatively, the process 1400 may include determining, utilizing flight scheduling data associated with the aviation-based user platform, an unscheduled flight associated with at least one of the aerial vehicle or other aerial vehicles associated with the aerial vehicle flight broker. The process 1400 may also include causing the web page to display the unscheduled flight and a time when the unscheduled flight is available for use.

Additionally, or alternatively, the process 1400 may include receiving, via the web page, a search query for unscheduled flights, the search query indicating a desired departure time and one or more attributes of a desired aerial vehicle. The process 1400 may also include determining that the unscheduled flight is associated with the one or more attributes and the desired time corresponds to the time. In these examples, causing the web page to display the unscheduled flight and the time may be based at least in part on the unscheduled flight being associated with the one or more attributes and the desired time corresponding to the time.

Additionally, or alternatively, the process 1400 may include receiving, via the web page, proxy authorization input from the aerial vehicle traveler, the proxy authorization input authorizing a user profile of a person other than the aerial vehicle traveler to request and confirm use of the aerial vehicles on behalf of the aerial vehicle traveler. The process 1400 may also include storing an indication of the proxy authorization input in a database associated with the aviation-based user platform. The process 1400 may also include determining the user profile is associated with the traveler input indicating the desire to use the aerial vehicle. The process 1400 may also include determining, based at least in part on the indication, that the user profile is authorized to request and confirm use of the aerial vehicle on behalf of the aerial vehicle traveler. In these examples, causing display of the traveler input on the first device associated with the aerial vehicle flight broker may be based at least in part on the user profile being authorized to request and confirm the use of the aerial vehicle.

Additionally, or alternatively, the process 1400 may include querying a database associated with the aviation-based user platform for flight information associated with the aerial vehicle, the aerial vehicle operator, and a scheduled flight of the aerial vehicle. The process 1400 may also include receiving traveler identifying information about the aerial vehicle traveler via the web page of the aerial vehicle flight broker. The process 1400 may also include generating flight scheduling data utilizing the flight information and the traveler identifying information. The process 1400 may also include sending the flight scheduling data to the aerial vehicle operator for confirmation of the flight scheduling data and receiving confirmation from the aerial vehicle operator that the flight scheduling data is accurate. The process 1400 may also include causing display, on the web page and to the aerial vehicle traveler, a flight schedule corresponding to the flight scheduling data and an indication that the flight schedule is confirmed by the aerial vehicle operator.

Additionally, or alternatively, the process 1400 may include causing, utilizing the aviation-based user platform, funds to be transferred from a first account associated with the aerial vehicle traveler to a second account associated with the aviation-based user platform. The process 1400 may also include, in response to a predetermined event occurring, causing: a first portion of the funds to be transferred from the second account to a third account associated with the aerial vehicle flight broker; and a second portion of the funds to be transferred from the second account to a fourth account associated with the aerial vehicle operator.

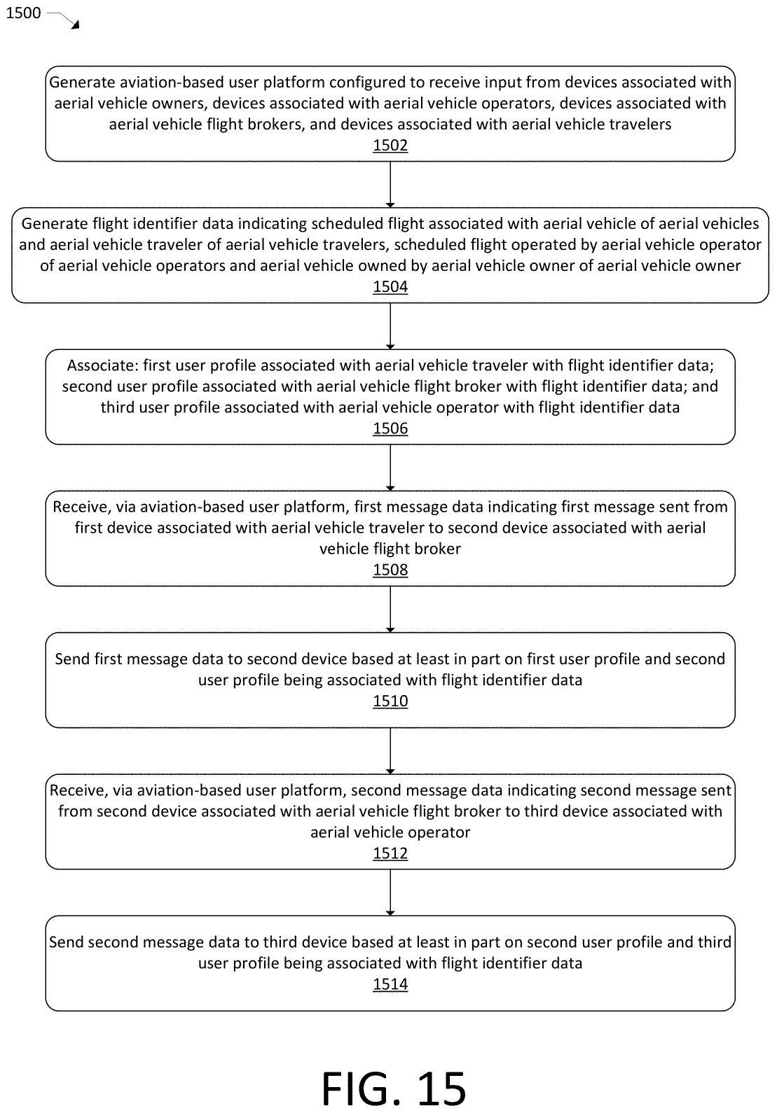

FIG. 15 illustrates a flow diagram of an example process 1500 for messaging security associated with an aviation-based user platform. The order in which the operations or steps are described is not intended to be construed as a limitation, and any number of the described operations may be combined in any order and/or in parallel to implement process 1500.

At block 1502, the process 1500 may include generating an aviation-based user platform configured to receive input from devices associated with aerial vehicle owners, devices associated with aerial vehicle operators, devices associated with aerial vehicle flight brokers, and devices associated with aerial vehicle travelers. For example, the environment for which the aviation-based user platform may be utilized may include one or more traveler devices, one or more broker devices, one or more operator devices, and one or more owner devices. These devices may be any computing devices configured to receive user input and to display information. The environment may also include a remote system, which is remote from one or more of the traveler devices, the broker devices, the operator devices, and the owner devices. The remote system may include one or more components that may allow for use of the aviation-based user platform. For example, the remote system may include one or more user interfaces that may be configured for display on one or more of the traveler devices, the broker devices, the operator device, and/or the owner devices.

At block 1504, the process 1500 may include generating flight identifier data indicating a scheduled flight associated with an aerial vehicle of the aerial vehicles and an aerial vehicle traveler of the aerial vehicle travelers, the scheduled flight operated by an aerial vehicle operator of the aerial vehicle operators and the aerial vehicle owned by an aerial vehicle owner of the aerial vehicle owner. For example, the flight identifier data may indicate entities associated with a given flight booked utilizing the aviation-based user platform.

At block 1506, the process 1500 may include associating: a first user profile associated with the aerial vehicle traveler with the flight identifier data; a second user profile associated with the aerial vehicle flight broker with the flight identifier data; and a third user profile associated with the aerial vehicle operator with the flight identifier data. For example, the user profiles associated with the entities associated with the scheduled flight may be related such that those user profiles are associated with each other for purposes of the scheduled flight.

At block 1508, the process 1500 may include receiving, via the aviation-based user platform, first message data indicating a first message sent from a first device associated with the aerial vehicle traveler to a second device associated with the aerial vehicle flight broker. For example, the message data may include text data, audio data, and/or image data representing a message.

At block 1510, the process 1500 may include sending the first message data to the second device based at least in part on the first user profile and the second user profile being associated with the flight identifier data. For example, to maintain security and privacy as among devices associated with the aviation-based user platform, message data may only be sent when the sender and receipt profile are associated with each other in relation to a scheduled flight and/or in relation to a relationship identified by the user profiles of the entities associated with the message.

At block 1512, the process 1500 may include receiving, via the aviation-based user platform, second message data indicating a second message sent from the second device associated with the aerial vehicle flight broker to a third device associated with the aerial vehicle operator. This operation may be performed in the same or a similar manner as described with respect to block 1508.

At block 1514, the process 1500 may include sending the second message data to the third device based at least in part on the second user profile and the third user profile being associated with the flight identifier data. This operation may be performed in the same or a similar manner as described with respect to block 1510.

Additionally, or alternatively, the process 1500 may include receiving, via the aviation-based user platform, request data for a status of the scheduled flight from the first device associated with the aerial vehicle traveler. The process 1500 may also include determining a first geolocation of the aerial vehicle at the time of receiving the request data. The process 1500 may also include determining a second geolocation of one or more staff members associated with the scheduled flight at the time of receiving the request data. The process 1500 may also include causing a user interface of the aviation-based user platform to display indicators of the first geolocation and the second geolocation in relation to a departure location of the aerial vehicle for the scheduled flight.

Additionally, or alternatively, the process 1500 may include determining a geolocation of one or more staff members associated with the scheduled flight. The process 1500 may also include determining, based at least in part on the geolocation, an approximate amount of time for the one or more staff members to arrive at a departure location associated with the scheduled flight. The process 1500 may also include determining that the approximate amount of time is greater than a threshold amount of time associated with the scheduled flight departing at a scheduled time. The process 1500 may also include generating notification data indicating the approximate amount of time is greater than the threshold amount of time. The process 1500 may also include causing a user interface of the aviation-based user platform to display a notification corresponding to the notification data.

Additionally, or alternatively, the process 1500 may include determining that one or more characteristics associated with the scheduled flight have changed such that the scheduled flight will be delayed, the one or more characteristics including at least one of an issue with the aerial vehicle or an issue with a staff member associated with the scheduled flight. The process 1500 may also include determining, utilizing data stored in a database associated with the aviation-based user platform, an alternative action that would mitigate a delay of the scheduled flight. The process 1500 may also include causing the alternative action to be performed.

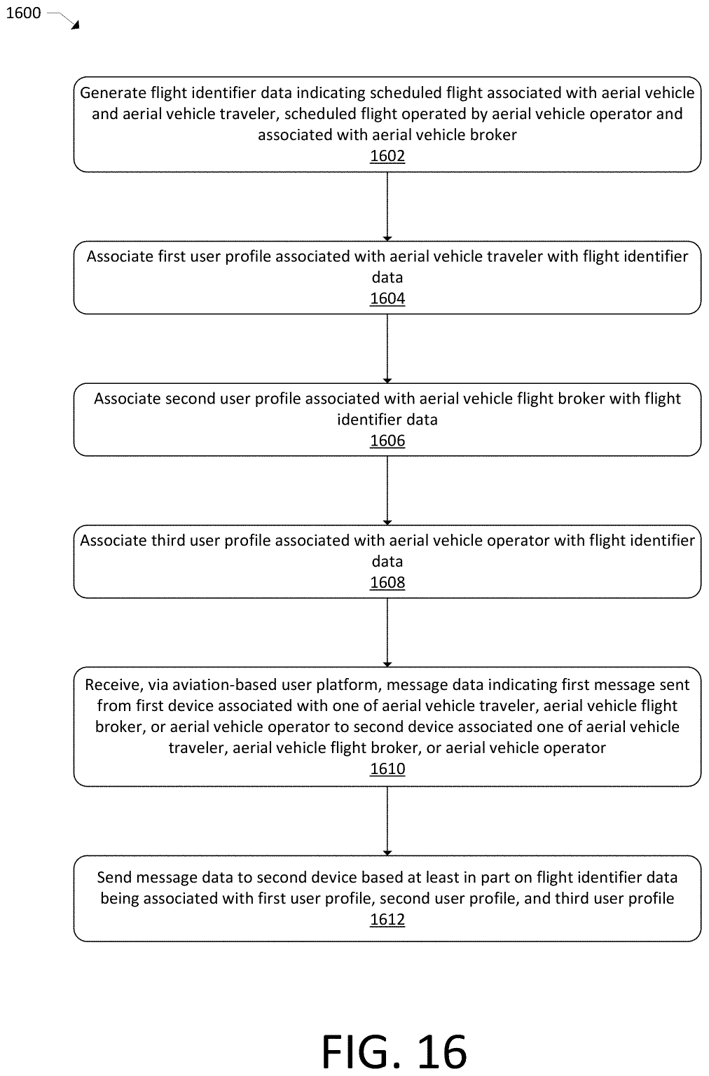

FIG. 16 illustrates a flow diagram of another example process 1600 for messaging security associated with an aviation-based user platform. The order in which the operations or steps are described is not intended to be construed as a limitation, and any number of the described operations may be combined in any order and/or in parallel to implement process 1600.

At block 1602, the process 1600 may include generating flight identifier data indicating a scheduled flight associated with an aerial vehicle and an aerial vehicle traveler, the scheduled flight operated by an aerial vehicle operator and associated with an aerial vehicle broker. For example, the flight identifier data may indicate entities associated with a given flight booked utilizing the aviation-based user platform.

At block 1604, the process 1600 may include associating a first user profile associated with the aerial vehicle traveler with the flight identifier data. For example, the user profiles associated with the entities associated with the scheduled flight may be related such that those user profiles are associated with each other for purposes of the scheduled flight.

At block 1606, the process 1600 may include associating a second user profile associated with the aerial vehicle flight broker with the flight identifier data. For example, the user profiles associated with the entities associated with the scheduled flight may be related such that those user profiles are associated with each other for purposes of the scheduled flight.

At block 1608, the process 1600 may include associating a third user profile associated with the aerial vehicle operator with the flight identifier data. For example, the user profiles associated with the entities associated with the scheduled flight may be related such that those user profiles are associated with each other for purposes of the scheduled flight.

At block 1610, the process 1600 may include receiving, via an aviation-based user platform, message data indicating a first message sent from a first device associated with one of the aerial vehicle traveler, the aerial vehicle flight broker, or the aerial vehicle operator to a second device associated one of the aerial vehicle traveler, the aerial vehicle flight broker, or the aerial vehicle operator. For example, the message data may include text data, audio data, and/or image data representing a message.

At block 1612, the process 1600 may include sending the message data to the second device based at least in part on the flight identifier data being associated with the first user profile, the second user profile, and the third user profile. For example, to maintain security and privacy as among devices associated with the aviation-based user platform, message data may only be sent when the sender and receipt profile are associated with each other in relation to a scheduled flight and/or in relation to a relationship identified by the user profiles of the entities associated with the message.

Additionally, or alternatively, the process 1600 may include receiving, via the aviation-based user platform, request data for a status of the scheduled flight from a computing device associated with the aerial vehicle traveler. The process 1600 may also include determining a geolocation of at least one of the aerial vehicle or one or more staff members associated with the schedule flight at the time of receiving the request data. The process 1600 may also include causing a user interface of the aviation-based user platform to display an indicator of the geolocation in relation to a departure location of the aerial vehicle for the scheduled flight.

Additionally, or alternatively, the process 1600 may include determining a geolocation of a staff member associated with the scheduled flight. The process 1600 may also include determining, based at least in part on the geolocation, an approximate amount of time for the staff member to arrive at a departure location associated with the schedule flight. The process 1600 may also include determining that the approximate amount of time is greater than a threshold amount of time. The process 1600 may also include causing a user interface of the aviation-based user platform to display a notification indicating the approximate amount of time is greater than the threshold amount of time.

Additionally, or alternatively, the process 1600 may include determining that a characteristic associated with the scheduled flight has changed such that the scheduled flight will be delayed. The process 1600 may also include determining, utilizing data stored in a database associated with the aviation-based user platform, an action that would mitigate a delay of the scheduled flight. The process 1600 may also include causing the alternative action to be performed.

Additionally, or alternatively, the process 1600 may include determining that a characteristic associated with the scheduled flight has changed such that the scheduled flight will be delayed. The process 1600 may also include determining, utilizing geolocation data associated with at least one of the aerial vehicle or one or more staff members associated with the scheduled flight, an action that would mitigate a delay of the scheduled flight. The process 1600 may also include causing the alternative action to be performed.

Additionally, or alternatively, the process 1600 may include determining, based at least in part on data stored in a databased of the aviation-based user platform, a likelihood that a staff member will arrive at a departure location associated with the schedule flight at a scheduled flight departure time. The process 1600 may also include determining that the likelihood is less than a threshold likelihood. The process 1600 may also include causing a user interface of the aviation-based user platform to display a notification indicating an alternative action that, if selected, would mitigate possible delay caused by late arrival of the staff member.

Additionally, or alternatively, the process 1600 may include receiving request data for use of the aerial vehicle and determining that the request data indicates that use of the aerial vehicle corresponds to an insurable use of the aerial vehicle. The process 1600 may also include determining a user profile associated with the aerial vehicle traveler. The process 1600 may also include determining that the user profile indicates an insurance plan associated with use of the aerial vehicle. The process 1600 may also include causing the aviation-based user platform to display an indication that a claim has been at least initiated utilizing information associated with the insurance plan.

Additionally, or alternatively, the process 1600 may include generating, for use in association with the aviation-based user platform, a user interface configured to receive user input data indicating at least user preferences associated with the scheduled flight and receiving the user input data via the user interface. The process 1600 may also include generating user preference data based at least in part on the user input data. The process 1600 may also include causing the user preference data to be available to the aerial vehicle operator and the aerial vehicle flight broker based at least in part on the flight identifier data being associated with the first user profile.

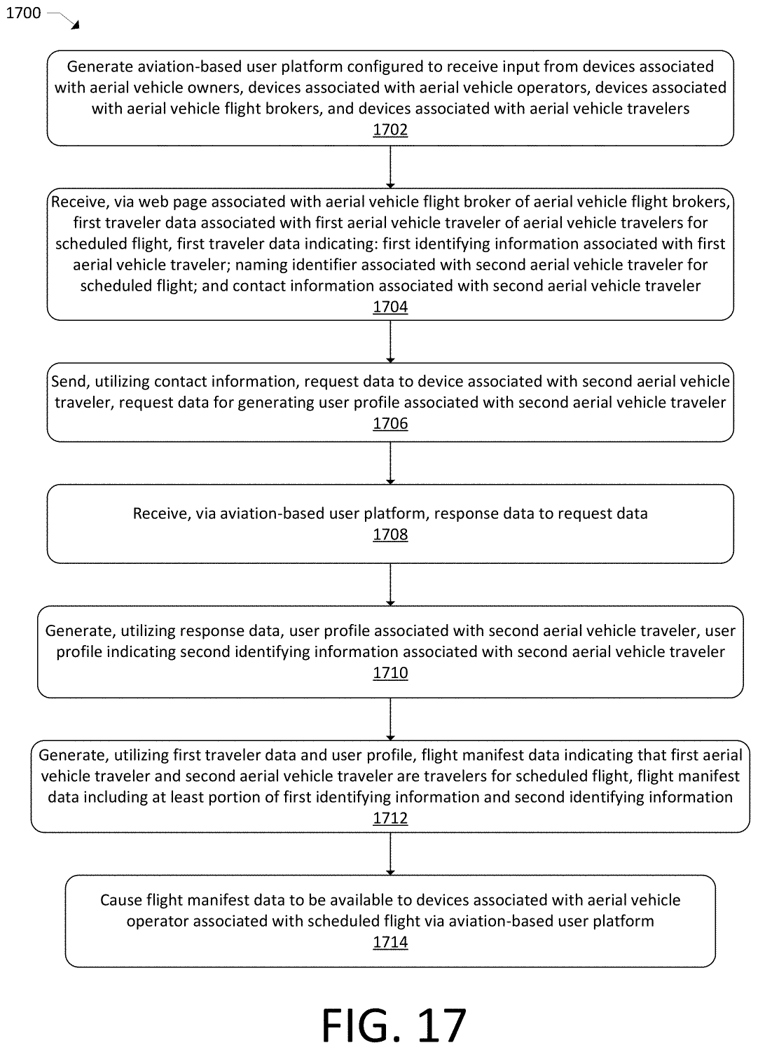

FIG. 17 illustrates a flow diagram of an example process 1700 for flight manifest data generation. The order in which the operations or steps are described is not intended to be construed as a limitation, and any number of the described operations may be combined in any order and/or in parallel to implement process 1700.

At block 1702, the process 1700 may include generating an aviation-based user platform configured to receive input from devices associated with aerial vehicle owners, devices associated with aerial vehicle operators, devices associated with aerial vehicle flight brokers, and devices associated with aerial vehicle travelers. For example, the environment for which the aviation-based user platform may be utilized may include one or more traveler devices, one or more broker devices, one or more operator devices, and one or more owner devices. These devices may be any computing devices configured to receive user input and to display information. The environment may also include a remote system, which is remote from one or more of the traveler devices, the broker devices, the operator devices, and the owner devices. The remote system may include one or more components that may allow for use of the aviation-based user platform. For example, the remote system may include one or more user interfaces that may be configured for display on one or more of the traveler devices, the broker devices, the operator device, and/or the owner devices.

At block 1704, the process 1700 may include receiving, via a web page associated with an aerial vehicle flight broker of the aerial vehicle flight brokers, first traveler data associated with a first aerial vehicle traveler of the aerial vehicle travelers for a scheduled flight, the first traveler data indicating: first identifying information associated with the first aerial vehicle traveler; a naming identifier associated with a second aerial vehicle traveler for the scheduled flight; and contact information associated with the second aerial vehicle traveler. For example, the first traveler data may be received utilizing the web page 302 described with respect to FIG. 3.

At block 1706, the process 1700 may include sending, utilizing the contact information, request data to a device associated with the second aerial vehicle traveler, the request data for generating a user profile associated with the second aerial vehicle traveler. For example, the request data may be sent in an attempt to gain identifying information for one or more other travelers other than the booking traveler.

At block 1708, the process 1700 may include receiving, via the aviation-based user platform, response data to the request data.

At block 1710, the process 1700 may include generating, utilizing the response data, the user profile associated with the second aerial vehicle traveler, the user profile indicating second identifying information associated with the second aerial vehicle traveler. For example, a user profile may be generated to allow the other travelers to utilize the aviation-based user platform in the same or a similar manner as the booking traveler, such as to book additional flights, provide input on user preferences, etc.

At block 1712, the process 1700 may include generating, utilizing the first traveler data and the user profile, flight manifest data indicating that the first aerial vehicle traveler and the second aerial vehicle traveler are travelers for the scheduled flight, the flight manifest data including at least a portion of the first identifying information and the second identifying information. For example, a manifest component of the remote system may be configured to generate flight manifest data for a given flight. For example, during the booking process, the booking traveler and/or a proxy may be asked to provide information for all travelers for the flight. The booking traveler and/or proxy may provide identifying information for the booking traveler as well as an identifier for other travelers and contact information for those travelers. The manifest component may utilize the contact information for the other travelers to send a request for information to those travelers. The request may include instructions for accessing the aviation-based platform for providing identifying information for the travelers and/or may enable the travelers to provide information for generating a user profile for the travelers. Once this data is received from the other travelers, the manifest component may be utilized to generate a flight manifest for the flight. The flight manifest may identify the travelers and at least a portion of identifying information about the travelers. The manifest may also include user preferences associated with the travelers, traveler restrictions and/or requests, and/or other data that may be required or desired for allowing the travelers to travel on the flight. The flight manifest data may be stored in one or more database of the aviation-based user platform and may be accessible to those entities that may require the flight manifest data, such as the operator, pilot, etc.

At block 1714, the process 1700 may include causing the flight manifest data to be available to devices associated with an aerial vehicle operator associated with the scheduled flight via the aviation-based user platform. For example, the flight manifest may be needed to confirm flight authorization of one or more travelers and/or to comply with one or more aviation regulations.

Additionally, or alternatively, the process 1700 may include in response to the first traveler data indicating the naming identifier associated with the second aerial vehicle traveler, sending an authorization request to the device associated with the second aerial vehicle traveler, the authorization request for user input data confirming that the second aerial vehicle traveler is currently using the device. The process 1700 may also include receiving the user input data. In these examples, sending the request data to the device may be in response to receiving the user input data.

Additionally, or alternatively, the process 1700 may include receiving, via the aviation-based user platform, first user preference data associated with the first aerial vehicle traveler. The process 1700 may also include receiving, via the aviation-based user platform, second user preference data associated with the second aerial vehicle traveler. The process 1700 may also include determining one or more differences between first user preferences corresponding to the first user preference data and second user preferences corresponding to the second user preference data. The process 1700 may also include automatically selecting one or more options associated with the scheduled flight based at least in part on the one or more differences.

Additionally, or alternatively, the process 1700 may include determining a portion of the second identifying information that is associated with sensitive information. The process 1700 may also include generating augmented flight manifest data with the portion of the second identifying information obfuscated. The process 1700 may also include receiving a query, via the aviation-based user platform, to display the flight manifest data, the query associated with the first aerial vehicle traveler. The process 1700 may also include in response to the query and based at least in part on the query being associated with the first aerial vehicle traveler, causing display of the augmented flight manifest data instead of the flight manifest data.

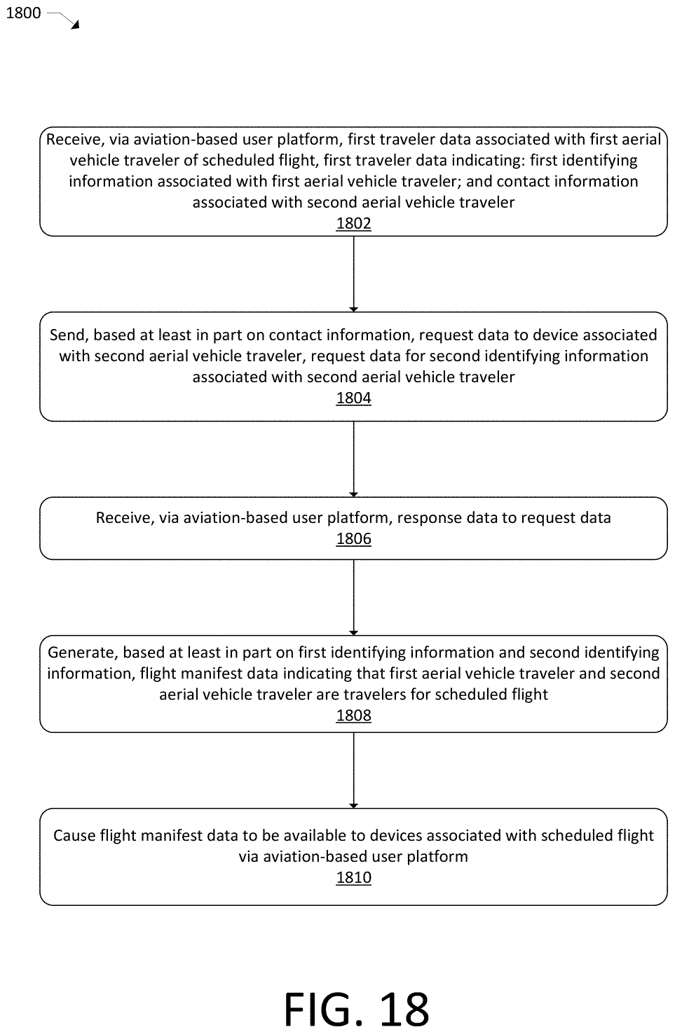

FIG. 18 illustrates a flow diagram of another example process 1800 for flight manifest data generation. The order in which the operations or steps are described is not intended to be construed as a limitation, and any number of the described operations may be combined in any order and/or in parallel to implement process 1800.

At block 1802, the process 1800 may include receiving, via an aviation-based user platform, first traveler data associated with a first aerial vehicle traveler of a scheduled flight, the first traveler data indicating: first identifying information associated with the first aerial vehicle traveler; and contact information associated with a second aerial vehicle traveler. For example, the first traveler data may be received utilizing the web page 302 described with respect to FIG. 3.

At block 1804, the process 1800 may include sending, based at least in part on the contact information, request data to a device associated with the second aerial vehicle traveler, the request data for second identifying information associated with the second aerial vehicle traveler. For example, the request data may be sent in an attempt to gain identifying information for one or more other travelers other than the booking traveler.

At block 1806, the process 1800 may include receiving, via the aviation-based user platform, response data to the request data.

At block 1808, the process 1800 may include generating, based at least in part on the first identifying information and the second identifying information, flight manifest data indicating that the first aerial vehicle traveler and the second aerial vehicle traveler are travelers for the scheduled flight. For example, a manifest component of the remote system may be configured to generate flight manifest data for a given flight. For example, during the booking process, the booking traveler and/or a proxy may be asked to provide information for all travelers for the flight. The booking traveler and/or proxy may provide identifying information for the booking traveler as well as an identifier for other travelers and contact information for those travelers. The manifest component may utilize the contact information for the other travelers to send a request for information to those travelers. The request may include instructions for accessing the aviation-based platform for providing identifying information for the travelers and/or may enable the travelers to provide information for generating a user profile for the travelers. Once this data is received from the other travelers, the manifest component may be utilized to generate a flight manifest for the flight. The flight manifest may identify the travelers and at least a portion of identifying information about the travelers. The manifest may also include user preferences associated with the travelers, traveler restrictions and/or requests, and/or other data that may be required or desired for allowing the travelers to travel on the flight. The flight manifest data may be stored in one or more database of the aviation-based user platform and may be accessible to those entities that may require the flight manifest data, such as the operator, pilot, etc.

At block 1810, the process 1800 may include causing the flight manifest data to be available to devices associated with the scheduled flight via the aviation-based user platform. For example, the flight manifest may be needed to confirm flight authorization of one or more travelers and/or to comply with one or more aviation regulations.

Additionally, or alternatively, the process 1800 may include based at least in part on the first traveler data indicating the contact information, sending an authorization request to the device associated with the second aerial vehicle traveler, the authorization request for user input data confirming that the second aerial vehicle traveler is currently using the device. In these examples, sending the request data may be based at least in part on receiving the user input data.

Additionally, or alternatively, the process 1800 may include receiving, via the aviation-based user platform, first user preference data associated with the first aerial vehicle traveler. The process 1800 may also include receiving, via the aviation-based user platform, second user preference data associated with the second aerial vehicle traveler. The process 1800 may also include selecting an option associated with the scheduled flight based at least in part on the first user preference data and the second user preference data.

Additionally, or alternatively, the process 1800 may include determining a portion of the second identifying information that is associated with sensitive information. The process 1800 may also include generating augmented flight manifest data with the portion of the second identifying information obfuscated. The process 1800 may also include causing display of the augmented flight manifest data instead of the flight manifest data on devices other than the device associated with the second aerial vehicle traveler.

Additionally, or alternatively, the process 1800 may include generating, based at least in part on the first aerial vehicle traveler and the second aerial vehicle traveler being associated with the scheduled flight, a user interface configured to send and receive communications. The process 1800 may also include causing the user interface to be available, via the aviation-based user platform, to devices associated with at least one of the first aerial vehicle traveler or the second aerial vehicle traveler and restricting availability of the user interface to other devices.

Additionally, or alternatively, the process 1800 may include storing, in a database associated with the aviation-based user platform, the second identifying information. The process 1800 may also include determining that the second aerial vehicle traveler is associated with a second scheduled flight and querying the second identifying information from the database. The process 1800 may also include generating second flight manifest data for the second scheduled flight utilizing the second identifying information received from the database.

Additionally, or alternatively, the process 1800 may include receiving first user preference data associated with the first aerial vehicle traveler. The process 1800 may also include selecting a first option associated with the scheduled flight based at least in part on the first user preference data. The process 1800 may also include receiving second user preference data associated with the second aerial vehicle traveler and determining that at least a portion of the second user preference data conflicts with the first option. The process 1800 may also include selecting a second option associated with the scheduled flight instead of the first option.

Additionally, or alternatively, the process 1800 may include determining one or more devices associated with one or more staff members of the scheduled flight that have been indicated as needing the flight manifest data. The process 1800 may also include sending the flight manifest data to the one or more devices.

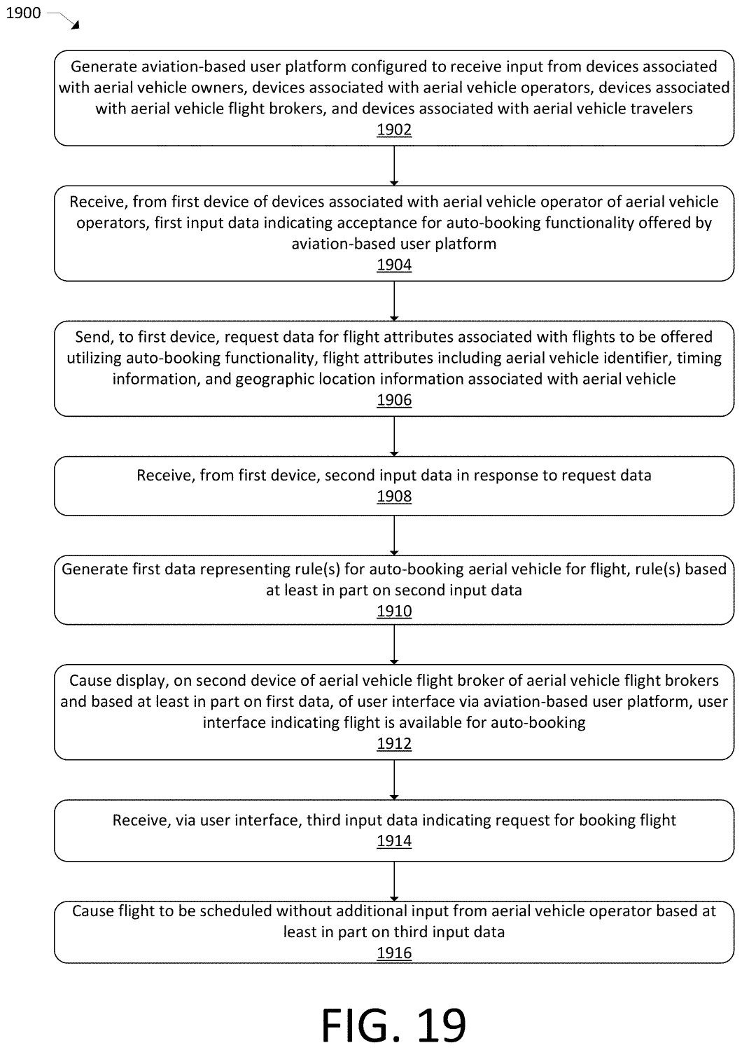

FIG. 19 illustrates a flow diagram of an example process 1900 for enabling and utilizing auto-booking functionality associated with an aviation-based user platform. The order in which the operations or steps are described is not intended to be construed as a limitation, and any number of the described operations may be combined in any order and/or in parallel to implement process 1900.

At block 1902, the process 1900 may include generating an aviation-based user platform configured to receive input from devices associated with aerial vehicle owners, devices associated with aerial vehicle operators, devices associated with aerial vehicle flight brokers, and devices associated with aerial vehicle travelers. For example, the environment for which the aviation-based user platform may be utilized may include one or more traveler devices, one or more broker devices, one or more operator devices, and one or more owner devices. These devices may be any computing devices configured to receive user input and to display information. The environment may also include a remote system, which is remote from one or more of the traveler devices, the broker devices, the operator devices, and the owner devices. The remote system may include one or more components that may allow for use of the aviation-based user platform. For example, the remote system may include one or more user interfaces that may be configured for display on one or more of the traveler devices, the broker devices, the operator device, and/or the owner devices.

At block 1904, the process 1900 may include receiving, from a first device of the devices associated with an aerial vehicle operator of the aerial vehicle operators, first input data indicating acceptance for auto-booking functionality offered by the aviation-based user platform. For example, the first input data may be received utilizing the user interface 500 described with respect to FIG. 5.

At block 1906, the process 1900 may include sending, to the first device, request data for flight attributes associated with flights to be offered utilizing the auto-booking functionality, the flight attributes including an aerial vehicle identifier, timing information, and geographic location information associated with the aerial vehicle. For example, the request data may request information about how the operator would like to apply the auto-booking functionality. The operator may allow for complete auto-booking of all flights, or may provide input such that only certain flights are to be associated with auto-booking functionality.

At block 1908, the process 1900 may include receiving, from the first device, second input data in response to the request data.

At block 1910, the process 1900 may include generating first data representing one or more rules for auto-booking the aerial vehicle for a flight, the one or more rules based at least in part on the second input data. The rules may indicate which flights are to be associated with auto-booking functionality without the operator needing to specifically call out a given flight on a given day at a given time associated with given travelers and a given aerial vehicle.

At block 1912, the process 1900 may include causing display, on a second device of an aerial vehicle flight broker of the aerial vehicle flight brokers and based at least in part on the first data, of a user interface via the aviation-based user platform, the user interface indicating the flight is available for auto-booking. For example, the user interface 300 described with respect to FIG. 3 may be causing to display flight options for a traveler, and the flight options may include an indication that one or more of the flights is associated with auto-booking functionality.

At block 1914, the process 1900 may include receiving, via the user interface, third input data indicating a request for booking the flight. This input data may be received via the user interface 300 described with respect to FIG. 3.

At block 1916, the process 1900 may include causing the flight to be scheduled without additional input from the aerial vehicle operator based at least in part on the third input data. For example, a scheduling component of the remote system may be utilized to schedule the flight without requesting confirmation from the operator and/or the owner prior to booking.

Additionally, or alternatively, the process 1900 may include determining, utilizing the aerial vehicle identifier and at the time the third input data is received, a scheduled geographic location of the aerial vehicle at a departure time of the flight. The process 1900 may also include determining that the scheduled geographic location corresponds to a reference geographic location associated with the one or more rules. In these examples, causing the flight to be scheduled may be based at least in part on the scheduled geographic location corresponding to the reference geographic location.

Additionally, or alternatively, the process 1900 may include receiving, utilizing the user interface of the aviation-based user platform, second request data from the aerial vehicle broker indicating one or more flights for which auto-booking is requested. In these examples, the first request data for flight attributes may be sent based at least in part on receiving the second request data, and the first data representing the one or more rules may be generated based at least in part on the second request data.

Additionally, or alternatively, the process 1900 may include determining, within a predetermined period of time from when the flight is scheduled to depart, that a geographic location of the aerial vehicle is more than a threshold distance from a reference geographic location associated with the one or more rules. The process 1900 may also include identifying an alternative aerial vehicle based at least in part on the geographic location being more than the threshold distance from the reference geographic location. The process 1900 may also include causing the alternative aerial vehicle to be associated with the flight instead of the aerial vehicle.

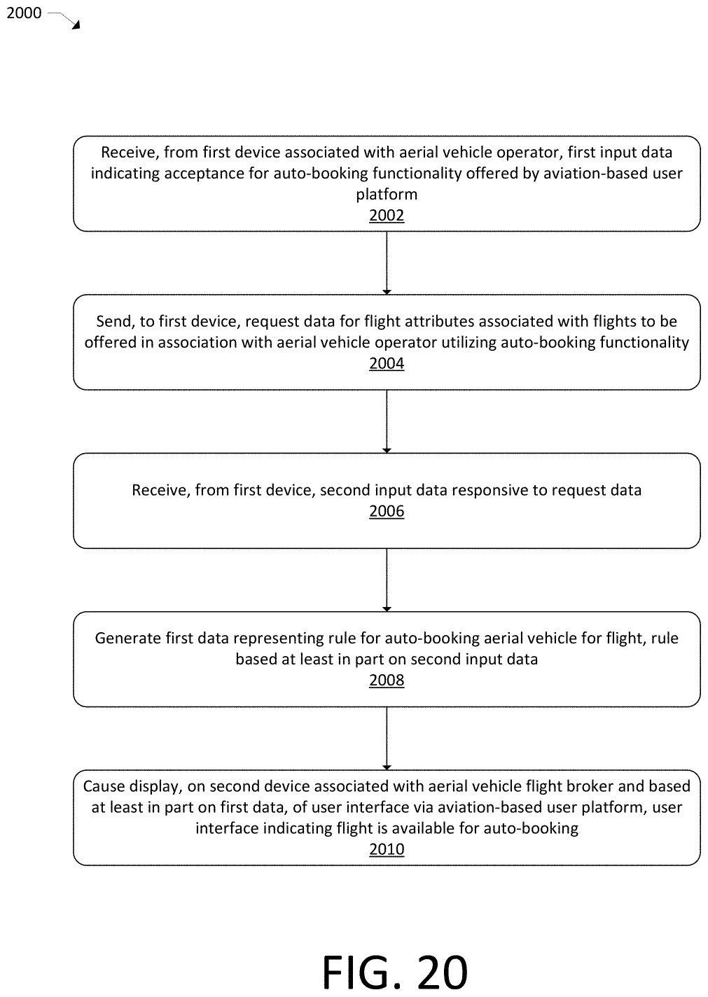

FIG. 20 illustrates a flow diagram of another example process 2000 for enabling and utilizing auto-booking functionality associated with an aviation-based user platform. The order in which the operations or steps are described is not intended to be construed as a limitation, and any number of the described operations may be combined in any order and/or in parallel to implement process 2000.

At block 2002, the process 2000 may include receiving, from a first device associated with an aerial vehicle operator, first input data indicating acceptance for auto-booking functionality offered by an aviation-based user platform. For example, the first input data may be received utilizing the user interface 500 described with respect to FIG. 5.

At block 2004, the process 2000 may include sending, to the first device, request data for flight attributes associated with flights to be offered in association with the aerial vehicle operator utilizing the auto-booking functionality. For example, the request data may request information about how the operator would like to apply the auto-booking functionality. The operator may allow for complete auto-booking of all flights, or may provide input such that only certain flights are to be associated with auto-booking functionality.

At block 2006, the process 2000 may include receiving, from the first device, second input data responsive to the request data.

At block 2008, the process 2000 may include generating first data representing a rule for auto-booking an aerial vehicle for a flight, the rule based at least in part on the second input data. The rules may indicate which flights are to be associated with auto-booking functionality without the operator needing to specifically call out a given flight on a given day at a given time associated with given travelers and a given aerial vehicle.

At block 2010, the process 2000 may include causing display, on a second device associated with an aerial vehicle flight broker and based at least in part on the first data, of a user interface via the aviation-based user platform, the user interface indicating the flight is available for auto-booking. For example, the user interface 300 described with respect to FIG. 3 may be causing to display flight options for a traveler, and the flight options may include an indication that one or more of the flights is associated with auto-booking functionality.

Additionally, or alternatively, the process 2000 may include determining a scheduled geographic location of the aerial vehicle at the time of the flight. The process 2000 may also include determining that the scheduled geographic location corresponds to a reference geographic location associated with the a rule. The process 2000 may also include causing the flight to be scheduled based at least in part on the scheduled geographic location corresponding to the reference geographic location.

Additionally, or alternatively, the process 2000 may include receiving, utilizing the user interface of the aviation-based user platform, second request data from the aerial vehicle broker indicating one or more flights for which auto-booking is requested. In these examples, the first request data may be sent based at least in part on receiving the second request data, and the first data representing the rule may be generated based at least in part on the second request data.

Additionally, or alternatively, the process 2000 may include determining, within a predetermined period of time from when the flight is scheduled to depart, that a geographic location of the aerial vehicle is more than a threshold distance from a reference geographic location of the aerial vehicle associated with the rule. The process 2000 may also include identifying an alternative aerial vehicle based at least in part on the geographic location being more than the threshold distance from the reference geographic location. The process 2000 may also include causing the alternative aerial vehicle to be associated with the flight instead of the aerial vehicle.

Additionally, or alternatively, the process 2000 may include determining a rating associated with the aerial vehicle operator and determining that the rating satisfies a threshold rating indicating the aerial vehicle operator is a trusted aerial vehicle operator. The process 2000 may also include causing the auto-booking functionality to be activated based at least in part on the rating satisfying the threshold rating.

Additionally, or alternatively, the process 2000 may include determining that the aerial vehicle flight broker is one of a predetermined subset of aerial vehicle flight brokers associated with the aviation-based user platform, the predetermined subset of the aerial vehicle flight brokers representing trusted aerial vehicle flight brokers. In these examples, causing display of the user interface may be based at least in part on the aerial vehicle flight broker being one of the predetermined subset of the aerial vehicle flight brokers.

Additionally, or alternatively, the process 2000 may include generating a second user interface configured to be displayed on the first device, the second user interface including one or more options for changing one or more settings associated with the auto-booking functionality. The process 2000 may also include receiving, via the second user interface, third user input data indicating a change to the one or more settings. The process 2000 may also include causing the rule to be updated based at least in part on the third user input data.

While the foregoing invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims.

What is claimed is:

1. A system, comprising:
one or more processors; and
non-transitory computer-readable media storing computer-executable instructions that, when executed by the one or more processors, cause the one or more processors to perform operations comprising:
generating an aviation-based user platform configured to receive input from devices associated with aerial vehicle owners, devices associated with aerial vehicle operators, devices associated with aerial vehicle flight brokers, and devices associated with aerial vehicle travelers;
receiving, via a web page associated with an aerial vehicle flight broker of the aerial vehicle flight brokers, first traveler data associated with a first aerial vehicle traveler of the aerial vehicle travelers for a scheduled flight, the first traveler data indicating:
first identifying information associated with the first aerial vehicle traveler;
a naming identifier associated with a second aerial vehicle traveler for the scheduled flight; and
contact information associated with the second aerial vehicle traveler;
sending, utilizing the contact information, request data to a device associated with the second aerial vehicle traveler, the request data for generating a user profile associated with the second aerial vehicle traveler;
receiving, via the aviation-based user platform, response data to the request data;
generating, utilizing the response data, the user profile associated with the second aerial vehicle traveler, the user profile indicating second identifying information associated with the second aerial vehicle traveler;
generating, utilizing the first traveler data and the user profile, flight manifest data indicating that the first aerial vehicle traveler and the second aerial vehicle traveler are travelers for the scheduled flight, the flight manifest data including at least a portion of the first identifying information and the second identifying information; and
causing the flight manifest data to be available to devices associated with an aerial vehicle operator associated with the scheduled flight via the aviation-based user platform.

2. The system of claim 1, the operations further comprising:
in response to the first traveler data indicating the naming identifier associated with the second aerial vehicle traveler, sending an authorization request to the device associated with the second aerial vehicle traveler, the authorization request for user input data confirming that the second aerial vehicle traveler is currently using the device;
receiving the user input data; and
wherein sending the request data to the device is in response to receiving the user input data.

3. The system of claim 1, the operations further comprising:
receiving, via the aviation-based user platform, first user preference data associated with the first aerial vehicle traveler;
receiving, via the aviation-based user platform, second user preference data associated with the second aerial vehicle traveler;
determining one or more differences between first user preferences corresponding to the first user preference data and second user preferences corresponding to the second user preference data; and
automatically selecting one or more options associated with the scheduled flight based at least in part on the one or more differences.

4. The system of claim 1, the operations further comprising:
determining a portion of the second identifying information that is associated with sensitive information;
generating augmented flight manifest data with the portion of the second identifying information obfuscated;
receiving a query, via the aviation-based user platform, to display the flight manifest data, the query associated with the first aerial vehicle traveler; and
in response to the query and based at least in part on the query being associated with the first aerial vehicle traveler, causing display of the augmented flight manifest data instead of the flight manifest data.

5. A method, comprising:
receiving, via an aviation-based user platform, first traveler data associated with a first aerial vehicle traveler of a scheduled flight, the first traveler data indicating:
first identifying information associated with the first aerial vehicle traveler; and
contact information associated with a second aerial vehicle traveler;
sending, based at least in part on the contact information, request data to a device associated with the second aerial vehicle traveler, the request data for second identifying information associated with the second aerial vehicle traveler;
receiving, via the aviation-based user platform, response data to the request data;
generating, based at least in part on the first identifying information and the second identifying information, flight manifest data indicating that the first aerial vehicle traveler and the second aerial vehicle traveler are travelers for the scheduled flight; and
causing the flight manifest data to be available to devices associated with the scheduled flight via the aviation-based user platform.

6. The method of claim 5, further comprising:
based at least in part on the first traveler data indicating the contact information, sending an authorization request to the device associated with the second aerial vehicle traveler, the authorization request for user input data confirming that the second aerial vehicle traveler is currently using the device; and
wherein sending the request data to the device comprises sending the request data based at least in part on receiving the user input data.

7. The method of claim 5, further comprising:
receiving, via the aviation-based user platform, first user preference data associated with the first aerial vehicle traveler;
receiving, via the aviation-based user platform, second user preference data associated with the second aerial vehicle traveler; and
selecting an option associated with the scheduled flight based at least in part on the first user preference data and the second user preference data.

8. The method of claim 5, further comprising:
determining a portion of the second identifying information that is associated with sensitive information;
generating augmented flight manifest data with the portion of the second identifying information obfuscated; and
causing display of the augmented flight manifest data instead of the flight manifest data on devices other than the device associated with the second aerial vehicle traveler.

9. The method of claim 5, further comprising:
generating, based at least in part on the first aerial vehicle traveler and the second aerial vehicle traveler being associated with the scheduled flight, a user interface configured to send and receive communications;
causing the user interface to be available, via the aviation-based user platform, to devices associated with at least one of the first aerial vehicle traveler or the second aerial vehicle traveler; and
restricting availability of the user interface to other devices.

10. The method of claim 5, wherein the scheduled flight comprises a first scheduled flight, the flight manifest data comprises first flight manifest data, and the method further comprises:
storing, in a database associated with the aviation-based user platform, the second identifying information;
determining that the second aerial vehicle traveler is associated with a second scheduled flight;
querying the second identifying information from the database; and
generating second flight manifest data for the second scheduled flight utilizing the second identifying information received from the database.

11. The method of claim 5, further comprising:
receiving first user preference data associated with the first aerial vehicle traveler;
selecting a first option associated with the scheduled flight based at least in part on the first user preference data;
receiving second user preference data associated with the second aerial vehicle traveler;
determining that at least a portion of the second user preference data conflicts with the first option; and
selecting a second option associated with the scheduled flight instead of the first option.

12. The method of claim 5, further comprising:
determining one or more devices associated with one or more staff members of the scheduled flight that have been indicated as needing the flight manifest data; and
sending the flight manifest data to the one or more devices.

13. A system, comprising:
one or more processors; and
non-transitory computer-readable media storing computer-executable instructions that, when executed by the one or more processors, cause the one or more processors to perform operations comprising:
receiving, via an aviation-based user platform, first traveler data associated with a first aerial vehicle traveler of for a scheduled flight, the first traveler data indicating:
first identifying information associated with the first aerial vehicle traveler; and
contact information associated with a second aerial vehicle traveler;
sending, based at least in part on the contact information, request data to a device associated with the second aerial vehicle traveler, the request data for second identifying information associated with the second aerial vehicle traveler;
receiving, via the aviation-based user platform, response data to the request data;
generating, based at least in part on the first identifying information and the second identifying information, flight manifest data indicating that the first aerial vehicle traveler and the second aerial vehicle traveler are travelers for the scheduled flight; and
causing the flight manifest data to be available to devices associated with the scheduled flight via the aviation-based user platform.

14. The system of claim 13, the operations further comprising:
based at least in part on the first traveler data indicating the contact information, sending an authorization request to the device associated with the second aerial vehicle traveler, the authorization request for user input data confirming that the second aerial vehicle traveler is currently using the device; and
wherein sending the request data to the device comprises sending the request data based at least in part on receiving the user input data.

15. The system of claim 13, the operations further comprising:
receiving, via the aviation-based user platform, first user preference data associated with the first aerial vehicle traveler;
receiving, via the aviation-based user platform, second user preference data associated with the second aerial vehicle traveler; and
selecting an option associated with the scheduled flight based at least in part on the first user preference data and the second user preference data.

16. The system of claim 13, the operations further comprising:
determining a portion of the second identifying information that is associated with sensitive information;
generating augmented flight manifest data with the portion of the second identifying information obfuscated; and
causing display of the augmented flight manifest data instead of the flight manifest data on devices other than the device associated with the second aerial vehicle traveler.

17. The system of claim 13, the operations further comprising:
generating, based at least in part on the first aerial vehicle traveler and the second aerial vehicle traveler being associated with the scheduled flight, a user interface configured to send and receive communications;
causing the user interface to be available, via the aviation-based user platform, to devices associated with at least one of the first aerial vehicle traveler or the second aerial vehicle traveler; and
restricting availability of the user interface to other devices.

18. The system of claim 13, wherein the scheduled flight comprises a first scheduled flight, the flight manifest data comprises first flight manifest data, and the operations further comprise:
storing, in a database associated with the aviation-based user platform, the second identifying information;
determining that the second aerial vehicle traveler is associated with a second scheduled flight;
querying the second identifying information from the database; and
generating second flight manifest data for the second scheduled flight utilizing the second identifying information received from the database.

19. The system of claim 13, the operations further comprising:
receiving first user preference data associated with the first aerial vehicle traveler;
selecting a first option associated with the scheduled flight based at least in part on the first user preference data;
receiving second user preference data associated with the second aerial vehicle traveler;
determining that at least a portion of the second user preference data conflicts with the first option; and
selecting a second option associated with the scheduled flight instead of the first option.

20. The system of claim 13, the operations further comprising:
determining one or more devices associated with one or more staff members of the scheduled flight that have been indicated as needing the flight manifest data; and
sending the flight manifest data to the one or more devices.
